(19) United States
(12) Patent Application Publication
(10) Pub. No.: US 2024/0104598 A1
(43) Pub. Date: Mar. 28, 2024

(54) INFORMATION PROCESSING APPARATUS, INFORMATION PROCESSING SYSTEM, INFORMATION PROCESSING METHOD, AND NON-TRANSITORY COMPUTER-READABLE MEDIUM

(71) Applicant: NEC Corporation, Minato-ku, Tokyo (JP)

(72) Inventors: Takashi Saitou, Tokyo (JP); Tadashi Natsukawa, Tokyo (JP)

(73) Assignee: NEC Corporation, Minato-ku, Tokyo (JP)

(21) Appl. No.: 18/275,138

(22) PCT Filed: Sep. 30, 2021
(86) PCT No.: PCT/JP2021/036095

§ 371 Date: Jul. 31, 2023

(51) Int. Cl. G06Q 30/0207; G06V 40/10

(52) U.S. Cl. CPC G06Q 30/0224; G06V 40/103

(57) ABSTRACT

An information processing apparatus (10) includes: an image acquisition unit (12) that acquires a captured image of at least one of a user who visits a first shop and a vehicle used by the user; a user specifying unit (13) that specifies the user or the vehicle based on the captured image; a selection unit (15) that selects, as recommended sales promotion information, at least one piece of sales promotion information from pieces of sales promotion information related to a product or service dealing in the first shop, based on a usage history regarding the user or the vehicle at a plurality of shops; and an output control unit (16) that outputs the recommended sales promotion information.

### TECHNICAL FIELD

The present disclosure relates to an information processing apparatus, an information processing system, an information processing method, and a non-transitory computer-readable medium, and more particularly to an information processing apparatus, an information processing system, an information processing method, and a non-transitory computer-readable medium that output sales promotion information of a shop.

### BACKGROUND ART

In recent years, each shop is considering conducting sales promotion activities adapted to each customer in order to provide high value-added services in a service station business such as gas station management. However, at present, customer information capable of being acquired by each shop is limited, and customer information cannot be abundantly acquired as materials for selecting products and services adapted to a user.

A system has been proposed herein for collectively managing customer information of each shop. For example, Patent Literature 1 disclose a shop sales promotion apparatus that stores customer information including shop visit history information related to a plurality of shops in association with vehicle number information, and outputs customer information associated with vehicle number information of a vehicle that has visited the shop.

### CITATION LIST

### Patent Literature

Patent Literature 1: Japanese Unexamined Patent Application Publication No. 2018-092629

### SUMMARY OF INVENTION

### Technical Problem

Each shop has a need to increase the profit of the corresponding shop by selling products and services handled by the corresponding shop while providing services with high added value to users. In the method in Patent Literature 1 described above, however, a process is not disclosed of automatically suggesting specific products or services of the corresponding shop.

In view of the above-described problems, an object of the present disclosure is to provide an information processing apparatus, an information processing system, an information processing method, and a non-transitory computer-readable medium that suitably recommend product or services handled by a shop to users who visits the shop.

### Solution to Problem

An aspect of the present disclosure provides an information processing apparatus including:

image acquisition means for acquiring a captured image of at least one of a user who visits a first shop and a vehicle used by the user;

user specifying means for specifying the user or the vehicle based on the captured image;

selection means for selecting, as recommended sales promotion information, at least one piece of sales promotion information from pieces of sales promotion information related to a product or service handled by the first shop, based on a usage history regarding the user or the vehicle at a plurality of shops; and

output control means for outputting the recommended sales promotion information.

An aspect of the present disclosure provides an information processing system including:

an information processing apparatus; and

a terminal that provides information to a user who visits a first shop,

the information processing apparatus including:

image acquisition means for acquiring a captured image of at least one of a user who visits a first shop and a vehicle used by the user;

user specifying means for specifying the user or the vehicle based on the captured image;

selection means for selecting, as recommended sales promotion information, at least one piece of sales promotion information from pieces of sales promotion information related to a product or service handled by the first shop, based on a usage history regarding the user or the vehicle at a plurality of shops; and

output control means for outputting the recommended sales promotion information.

An aspect of the present disclosure provides an information processing method including:

acquiring a captured image of at least one of a user who visits a first shop and a vehicle used by the user;

specifying the user or the vehicle based on the captured image;

selecting, as recommended sales promotion information, at least one piece of sales promotion information from pieces of sales promotion information related to a product or service handled by the first shop, based on a usage history regarding the user or the vehicle at a plurality of shops; and outputting the recommended sales promotion information.

An aspect of the present disclosure provides a non-transitory computer-readable medium storing a program that causes a computer to execute:

an image acquisition process for acquiring a captured image of at least one of a user who visits a first shop and a vehicle used by the user;

a user specifying process for specifying the user or the vehicle based on the captured image;

a selection process for selecting, as recommended sales promotion information, at least one piece of sales promotion information from pieces of sales promotion information related to a product or service handled by the first shop, based on a usage history regarding the user or the vehicle at a plurality of shops; and

an output control process for outputting the recommended sales promotion information.

### Advantageous Effects of Invention

According to the present disclosure, it is possible to provide an information processing apparatus, an information processing system, an information processing method, and a non-transitory computer-readable medium that suitably recommend product or services handled by a shop to users who visit the shop.

### BRIEF DESCRIPTION OF DRAWINGS

FIG. 1 is a block diagram showing a configuration of an information processing apparatus according to a first example embodiment;

FIG. 2 is a flowchart showing a flow of an information processing method according to the first example embodiment;

FIG. 3 is a block diagram showing an overall configuration of an information processing system according to a second example embodiment;

FIG. 4 is a block diagram showing a configuration of a face authentication apparatus according to the second example embodiment;

FIG. 5 is a flowchart showing a flow of facial information registration processing according to the second example embodiment;

FIG. 6 is a flowchart showing face authentication processing according to the second example embodiment;

FIG. 7 is a block diagram showing a configuration of a user terminal according to the second example embodiment;

FIG. 8 is a block diagram showing a configuration of a shop terminal according to the second example embodiment;

FIG. 9 is a block diagram showing a configuration of a server according to the second example embodiment;

FIG. 10 is a diagram for explaining an example of relation information according to the second example embodiment;

FIG. 11 is a diagram showing an example of a data structure of a usage history DB according to the second example embodiment;

FIG. 12 is a sequence diagram showing a flow of member registration processing according to the second example embodiment;

FIG. 13 is a diagram showing an example of a display on a user terminal according to the second example embodiment;

FIG. 14 is a sequence diagram showing a flow of information provision processing according to the second example embodiment

FIG. 15 is a sequence diagram showing a flow of usage history registration processing according to the second example embodiment;

FIG. 16 is a diagram for explaining a purchase cycle according to the second example embodiment;

FIG. 17 is a diagram showing an example of a display on a shop terminal according to a second example embodiment;

FIG. 18 is a block diagram showing a configuration of a server according to a third example embodiment;

FIG. 19 is a sequence diagram showing a flow of opportunity loss calculation processing according to the third example embodiment;

FIG. 20 is a block diagram showing a configuration of a server according to a fourth example embodiment;

FIG. 21 is a sequence diagram showing a flow of information provision processing according to the fourth example embodiment;

FIG. 22 is a diagram showing an example of a display on a shop terminal according to the fourth example embodiment;

FIG. 23 is a block diagram showing a configuration of a server according to a fifth example embodiment;

FIG. 24 is a diagram showing an example of a data structure of contract information according to the fifth example embodiment;

FIG. 25 is a sequence diagram showing a flow of information provision processing according to the fifth example embodiment;

FIG. 26 is a diagram showing an example of a display on a user terminal according to the fifth example embodiment;

FIG. 27 is a sequence diagram showing a flow of information sharing processing according to the fifth example embodiment;

FIG. 28 is a block diagram showing a configuration of a server according to a sixth example embodiment;

FIG. 29 is a sequence diagram showing a flow of information provision processing according to the sixth example embodiment;

FIG. 30 is a diagram showing an example of a display on a shop terminal according to the sixth example embodiment;

FIG. 31 is a diagram showing an example of a display on a shop terminal according to the sixth example embodiment;

FIG. 32 is a block diagram showing an overall configuration of an information processing system according to a seventh example embodiment;

FIG. 33 is a block diagram showing a configuration of a shop management apparatus according to the seventh example embodiment;

FIG. 34 is a block diagram showing a configuration of a server according to the seventh example embodiment; and

FIG. 35 is a sequence diagram showing a flow of information provision processing according to the seventh example embodiment.

### EXAMPLE EMBODIMENTS

Example embodiments of the present disclosure will be described in detail below with reference to the drawings. In each of the drawings, the same components or corresponding components are denoted by the same reference numerals, and will not be described repeatedly as necessary for clarity of description.

The following terms are defined below as follows. “User information” is information related to a user. The “user information” includes at least one of attribute information of the user and information indicating user's preference. Further, the “user information” may also include a usage history in addition to or instead of the information described above.

The “usage history” is information indicating that the user has used any one of a plurality of predetermined shops. The usage history includes a payment history.

“Relation information” indicates a business relationship between shops. “There is a business relationship” may indicate, for example, whether shops belong to the same affiliated group or whether the shop or the affiliated group thereof is in a business alliance relation or a capital alliance relation.

“Sales promotion information” may include basic information about a shop, information about products or services offered at the shop, or campaign information or special benefit information about the products or services.

“Maintenance” is used as a term including preparation, inspection, repair, or replacement.

“Personal identification information” is information for identifying a user himself/herself. The “personal identification information” is user's facial image or facial feature information, or a user ID that identifies a user.

“Information about vehicle state” is also called vehicle state information, and may indicate, for example, a specific site of a vehicle has failed, that a specific function is not operated, or that a specific function is malfunctioning.

“User's position information” may be position information of a user terminal, position information of a wearable terminal connected to the user terminal and worn on a body of the user, or position information of a vehicle of the user.

A “vehicle-related contract” is a contract for vehicle services. The “vehicle-related contract” may include a vehicle purchase contract, a vehicle rental/lease contract, a vehicle maintenance contract, or special benefit information associated with various contracts.

A “vehicle service” is a service related to a vehicle. For example, the “vehicle service” is a service related to vehicle inspection, insurance, maintenance, sales, car sharing, or rental car.

A “contractor shop” is a shop contracted with a user. For example, the “contractor shop” may include a shop where a user purchases, rents, or leases a vehicle.

“Using (products or services)” is to purchase products or to purchase services.

### First Example Embodiment

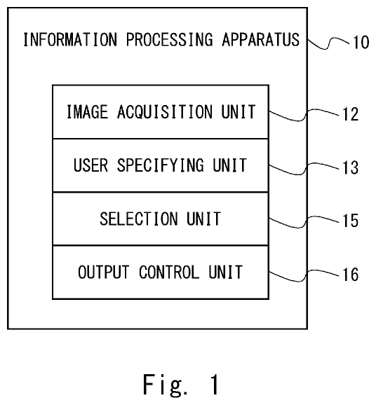

First, a first example embodiment of the present disclosure will be described. FIG. 1 is a block diagram showing a configuration of an information processing apparatus 10 according to a first example embodiment. The information processing apparatus 10 is a computer apparatus that outputs sales promotion information regarding products or services dealing in a first shop to which the user visits. The information processing apparatus 10 is connected to a network (not shown). The network may be wired or wireless. The network may be connected with a user terminal (not shown) used by the user or a shop terminal (not shown). The shop terminal is a terminal installed at the first shop to which the user visits, or a terminal used by a manager of the first shop to which the user visits. The shop terminal provides information to the user who visits to the first shop.

The information processing apparatus 10 includes an image acquisition unit 12, a user specifying unit 13, a selection unit 15, and an output control unit 16.

The image acquisition unit 12 is also called image acquisition means. The image acquisition unit 12 acquires a captured image of at least one of the user who visits to the first shop and a vehicle used by the user. For example, the image acquisition unit 12 acquires the captured image from the shop terminal.

The user specifying unit 13 is also called user specifying means. The user specifying unit 13 specifies a user or a vehicle based on the captured image acquired by the image acquisition unit 12. For example, the user specifying unit 13 specifies a user ID that identifies a user by face authentication. Further, for example, the user specifying unit 13 specifies a registration number of the vehicle from a license plate of the vehicle by number detection.

The selection unit 15 is also called selection means. The selection unit 15 selects, as recommended sales promotion information, at least one piece of sales promotion information from a plurality of pieces of sales promotion information regarding products or services dealing in the first shop, based on a usage history related to a user or vehicle at a plurality of shops. As an example, the selection unit 15 estimates a product or service according to a user's preference or necessary for the user based on the usage history collected at the plurality of shops, and selects sales promotion information regarding the product or service from the plurality of pieces of sales promotion information dealing in the first shop.

The output control unit 16 is also called output control means. The output control unit 16 outputs the recommended sales promotion information selected by the selection unit 15. For example, the output control unit 16 may transmit the selected recommended sales promotion information to the shop terminal of the first shop, and cause the shop terminal to output (display) the information. In this case, contents of the recommended sales promotion information may be displayed by the shop terminal so as to be capable of visually recognized by the user, or may be verbally informed to the user by a clerk using the shop terminal. A destination of transmission may be the user terminal without being limited to the shop terminal.

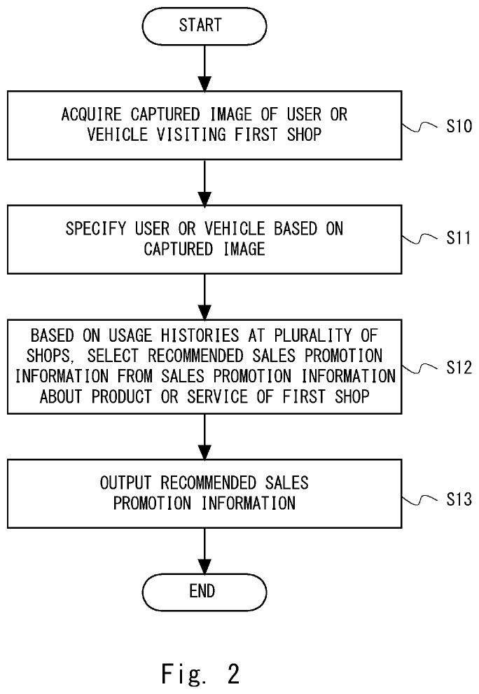

FIG. 2 is a flowchart showing a flow of an information processing method according to the first example embodiment. First, the image acquisition unit 12 of the information processing apparatus 10 acquires a captured image of a user or a vehicle that visits to a first shop (S10). Next, the user specifying unit 13 specifies the user or the vehicle based on the captured image (S11). Next, the selection unit 15 selects recommended sales promotion information from sales promotion information regarding products or services dealing in the first shop, based on a usage history at a plurality of shops (S12). Finally, the output control unit 16 outputs the selected recommended sales promotion information to the shop terminal or the user terminal (S13).

According to the first example embodiment as described above, for a user who has visited to a certain shop, products or services dealing in the shop are narrowed down based on the preference and needs of the user, and then preferably recommended. Therefore, it becomes easier to attract customers to the shop while increasing satisfaction of the user, leading to an increase in profits of the shop.

### Second Example Embodiment

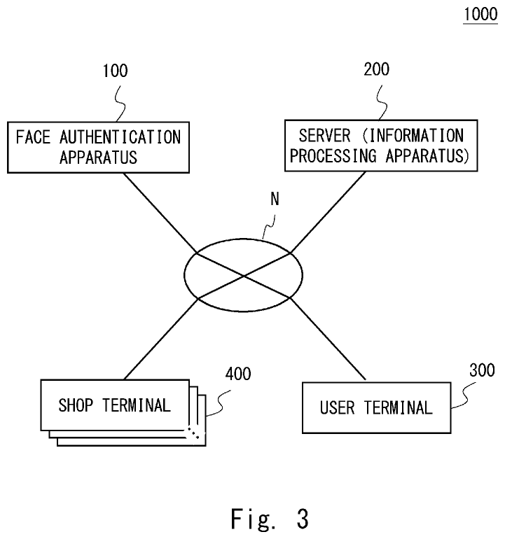

Next, a second example embodiment of the present disclosure will be described. FIG. 3 is a block diagram showing an overall configuration of an information processing system 1000 according to a second example embodiment. The information processing system 1000 is a computer system that provides a user with sales promotion information of one or a plurality of shops. In the second example embodiment, in order to encourage a user to visit a shop having a business relationship with a first shop serving as a shop to which the user has visited, the information processing system 1000 provides the user with sales promotion information of the shop.

The information processing system 1000 includes a face authentication apparatus 100, an information processing apparatus (hereinafter, referred to as a server) 200, a user terminal 300, and one or a plurality of shop terminals 400. The apparatuses and the terminals are connected to each other via a network N. The network N is a wired or wireless communication line.

The user terminal 300 is an information terminal used by a user.

The shop terminal 400 is an information terminal installed in each of a plurality of shops that provide in-shop services, or a terminal used by a manager of each shop. The in-shop service is a service in a form in which a user visits a shop to receive services, and may be a cosmetics sale, a vehicle sale, or a vehicle maintenance service.

The shop terminal 400 accepts face authentication for the user who visits the shop and uses the in-shop service, and provides sales promotion information of the corresponding shop or other shops according to the user when the face authentication is successful. In the present second example embodiment, the shop terminal 400 captures an image of at least a face of the user subjected to face authentication, and transmits a facial image (hereinafter, also referred to as a captured image) to the server 200. The face authentication is performed by the server 200 and the face authentication apparatus 100 via the shop terminal 400.

In addition, the shop terminal 400 transmits a usage history related to face payment for use of the in-shop service to the server 200, and causes the server 200 to accumulate the usage history of the user.

The face authentication apparatus 100 is an example of a biometric authentication apparatus, and is a computer apparatus that stores facial feature information of a plurality of persons. Further, the face authentication apparatus 100 has a face authentication function that, in response to a face authentication request received from the outside, collates an facial image or facial feature information included in the request with the facial feature information of each user. In the present second example embodiment, the face authentication apparatus 100 registers the facial feature information of the user at the time of member registration, which will be described below. Then, the face authentication apparatus 100 acquires the facial image of the user, who has visited the first shop, from the shop terminal 400 of the first shop via the server 200, and executes face authentication using the facial image. Then, the face authentication apparatus 100 replies the collation result (face authentication result) to the server 200.

The server 200 is a computer apparatus that provides the shop terminal 400 with the sales promotion information of one or the plurality of shops selected according to the user. First, the server 200 performs member registration on the user in response to a member registration request from the user terminal 300. Then, upon receiving an information provision request or a face payment request from the shop terminal 400, the server 200 executes processing according to the request and the user. The request includes the facial image or the facial feature information of the user who has visited the first shop. Upon receiving the request, the server 200 extracts the facial image or the facial feature information of the user from the request, and requests face authentication apparatus 100 to perform face authentication on a facial region. For example, upon receiving the information provision request, the server 200 transmits the sales promotion information of one or the plurality of shops to the shop terminal 400 according to the user specified by the face authentication, and causes the shop terminal 400 to display the information.

In addition, the server 200 collects a usage history related to face payment from the shop terminal 400 of each of the shops, and accumulates the collected usage history in a usage history database (DB).

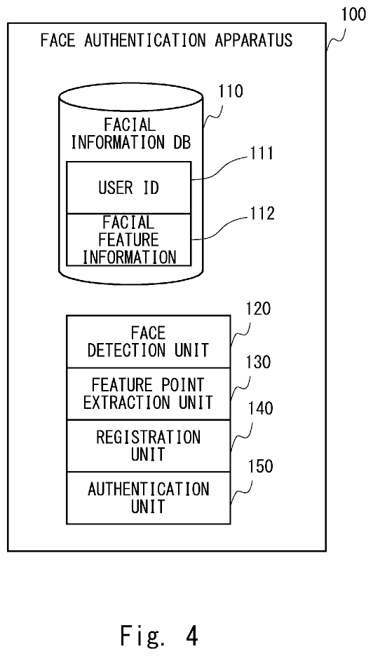

FIG. 4 is a block diagram showing a configuration of the face authentication apparatus 100 according to the second example embodiment. The face authentication apparatus 100 includes a facial information DB (DataBase) 110, a face detection unit 120, a feature point extraction unit 130, a registration unit 140, and an authentication unit 150. The facial information DB 110 stores a user ID 111 and facial feature information 112 of the user ID in association with each other. The user ID 111 is an information for identifying the user, for example, an identification number. The facial feature information 112 is a set of feature points extracted from the facial image, and is an example of facial information. The face authentication apparatus 100 may delete the facial feature information 112 in the facial feature DB 110 in response to a request from the registered user of the facial feature information 112. Alternatively, the face authentication apparatus 100 may delete the facial feature information 112 after a certain period of time from registration.

The face detection unit 120 detects a facial region included in a registered image for registering facial information, and supplies the detected facial region to the feature point extraction unit 130. The feature point extraction unit 130 extracts feature points from the facial region detected by the face detection unit 120, and supplies facial feature information to the registration unit 140. Further, the feature point extraction unit 130 extracts feature points included in the facial image received from the server 200, and supplies facial feature information to the authentication unit 150.

The registration unit 140 newly issues a user ID 111 at the time of registration of the facial feature information. The registration unit 140 registers the issued user ID 111 and the facial feature information 112 extracted from the registered image in the facial information DB 110 in association with each other. The authentication unit 150 performs face authentication using the facial feature information 112. Specifically, the authentication unit 150 collates the facial feature information extracted from the facial image with the facial feature information 112 in the facial information DB 110. The authentication unit 150 replies to the server 200 whether the facial feature information matches. Whether the facial feature information matches corresponds to a success or failure of the authentication. Note that the matching of the facial feature information (that the facial feature information matches) means a case where the degree of matching is equal to or greater than a predetermined value.

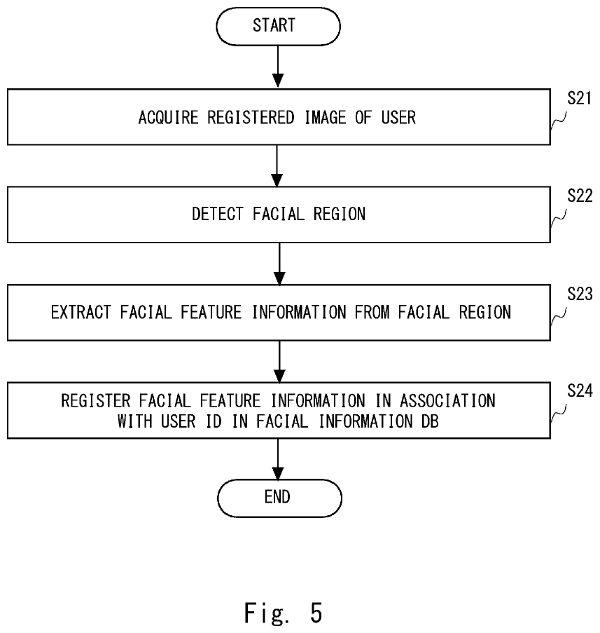

FIG. 5 is a flowchart showing a flow of facial information registration processing according to the second example embodiment. First, the face authentication apparatus 100 acquires a registered image of a user U included in a face registration request (S21). For example, the face authentication apparatus 100 receives the face registration request from the server 200, which has received the member registration request from the user terminal 300, via the network N. Note that, the face authentication apparatus 100 may receive the face registration request directly from the user terminal 300 without being limited thereto. Next, the face detection unit 120 detects a facial region included in the registered image (S22). Next, the feature point extraction unit 130 extracts feature points from the facial region detected in step S22, and supplies facial feature information to the registration unit 140 (S23). Finally, the registration unit 140 issues the user ID 111, and registers the user ID 111 and the facial feature information 112 in the facial information DB 110 in association with each other (S24). The face authentication apparatus 100 may receive the facial feature information 112 from a face registration requestor, and register it in the facial information DB 110 in association with the user ID 111.

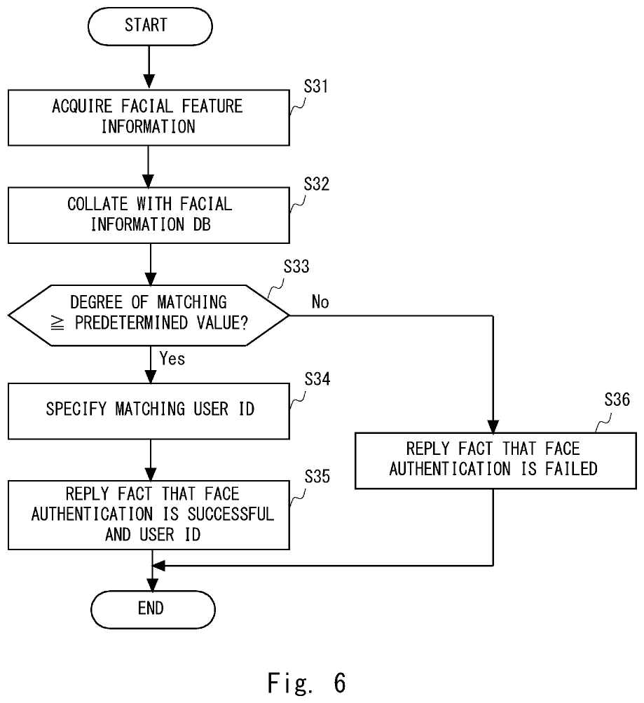

FIG. 6 is a flowchart showing face authentication processing according to the second example embodiment. First, the feature point extraction unit 130 acquires facial feature information for authentication (S31). For example, the face authentication apparatus 100 receives a face authentication request from the server 200 via the network N, and extracts facial feature information from the facial image included in the face authentication request as in steps S21 to S23. Alternatively, the face authentication apparatus 100 may receive the facial feature information from the server 200. Next, the authentication unit 150 collates the acquired facial feature information with the facial feature information 112 of the facial information DB 110 (S32). When the facial feature information matches, that is, when the degree of matching of the facial feature information is equal to or greater than a predetermined value (Yes in S33), the authentication unit 150 specifies the user ID 111 of the user whose facial feature information matches (S34). Then, the authentication unit 150 replies the fact that the face authentication is successful and the specified user ID 111 to the server 200, as a face authentication result (S35). When there is no matching facial feature information (No in S33), the authentication unit 150 replies the fact that the face authentication is failed, as a face authentication result, to the server 200 (S36).

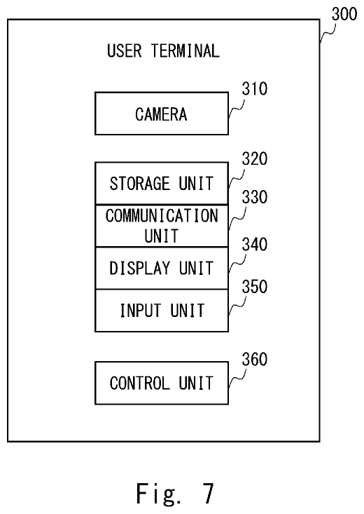

FIG. 7 is a block diagram showing a configuration of the user terminal 300 according to the second example embodiment. The user terminal 300 includes a camera 310, a storage unit 320, a communication unit 330, a display unit 340, and input unit 350, and a control unit 360.

The camera 310 is an image capturing apparatus that captures an image under control of the control unit 360. The storage unit 320 is a storage apparatus that stores programs for realizing functions of the user terminal 300. The communication unit 330 is a communication interface with the network N. The display unit 340 is a display apparatus. The input unit 350 is an input apparatus that receives an input from the user. The display unit 340 and the input unit 350 may be configured integrally like a touch panel. The control unit 360 controls hardware of the user terminal 300.

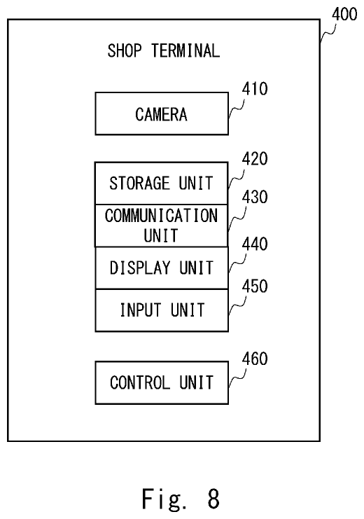

FIG. 8 is a block diagram showing a configuration of the shop terminal 400 according to the second example embodiment. The shop terminal 400 includes a camera 410, a storage unit 420, a communication unit 430, a display unit 440, an input unit 450, and a control unit 460.

The camera 410 is an image capturing apparatus that captures an image under control of the control unit 460. The storage unit 420 is a storage apparatus that stores programs for realizing functions of the shop terminal 400. The communication unit 430 is a communication interface with the network N. The display unit 440 is a display apparatus. The input unit 450 is an input apparatus that receives an input from the user. The display unit 440 and the input unit 450 may be configured integrally like a touch panel. The control unit 460 controls hardware of the shop terminal 400.

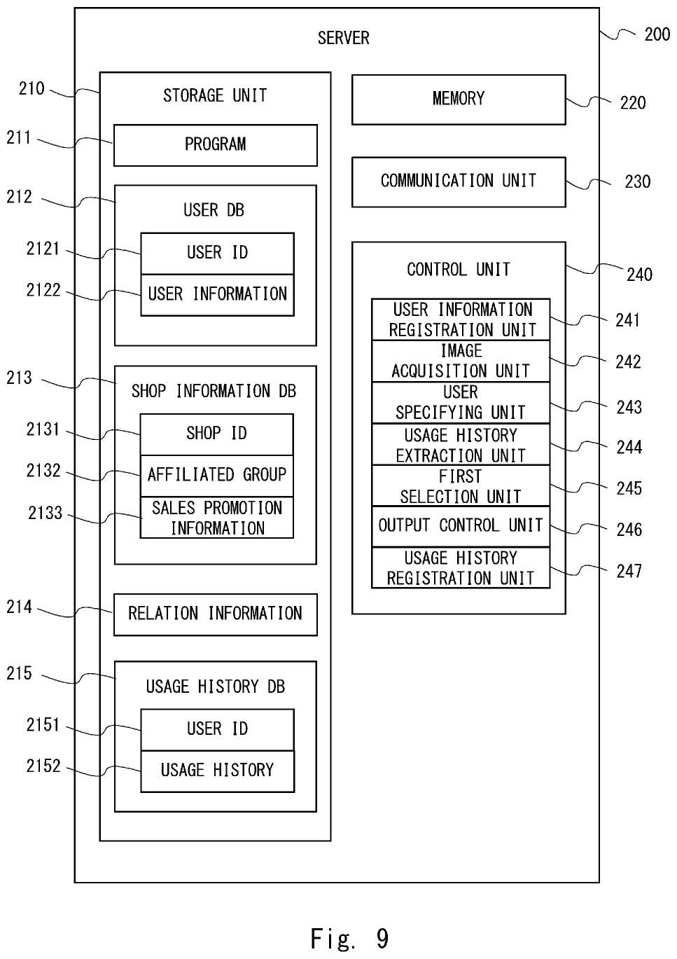

FIG. 9 is a block diagram showing a configuration of the server 200 according to the second example embodiment. The server 200 includes a storage unit 210, a memory 220, a communication unit 230, and a control unit 240. The storage unit 210 is a storage apparatus such as a hard disk or a flash memory. The storage unit 210 stores a program 211, a user DB 212, a shop information DB 213, a relation information 214, and a usage history DB 215. The program 211 is a computer program in which the processing of the information processing method according to the present second example embodiment is implemented.

The user DB 212 stores user information of a user who is a member. Specifically, the user DB 212 stores user information 2122 in association with a user ID 2121. The user ID 2121 may be issued by the face authentication apparatus 100 at the time of registration of the facial information. The user information 2122 is information about the user, and may include, for example, attribute information of the user and information indicating preference of the user. The attribute information may include at least one of age, place of residence, gender, family composition, workplace, allergy information, and religious information. The attribute information may include working environment, for example, indoor working or outdoor working. The information indicating the preference of the user may include information regarding at least one of a hobby of the user, a field of interest of the user, and a product or service evaluated by the user.

The shop information DB 213 is a database that shops various pieces of information related to a shop. Specifically, the shop information DB 213 includes a shop ID 2131, an affiliated group 2132, and sales promotion information 2133.

The shop ID 2131 is information for identifying a shop. The affiliated group 2132 is information about a group to which the shop belongs. For example, the affiliated group 2132 is a group ID that identifies the group to which the shop belongs. The sales promotion information 2133 includes basic information on the shop, information on products or services offered at the shop, or campaign information or special benefit information on the products or services.

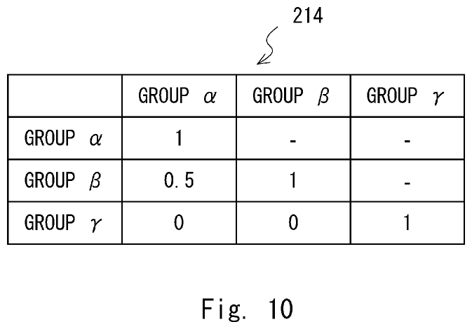

The relation information 214 is an example of the relation information described above. Here, a specific example of the relation information 214 will be described with reference to FIG. 10. FIG. 10 is a diagram for explaining an example of the relation information 214 according to the second example embodiment. The relation information 214 may be information indicating a business relationship between groups to which the shops belong, respectively, for example, information indicating the degree of relationship that quantifies the strength of the business relationship between the groups. As an example, when the affiliated groups of shops are the same, the degree of relationship is “1”, and when the affiliated groups are different from each other and there is neither a business alliance nor a capital alliance, the degree of relationship may be “0”.

Further, when the affiliated groups are different from each other but have some of business alliance or capital alliance, the degree of relationship may be “0” or more and less than “1”. In this diagram, the degree of relationship between a group a and a group β is “0.5”, and the degree of relationship between a group α and a group γ and between a group β and a group γ is “0”.

Alternatively or additionally, the relation information 214 may be information indicating a business relationship between shops, for example, information indicating the degree of relationship that quantifies the strength of the business relationship between shops.

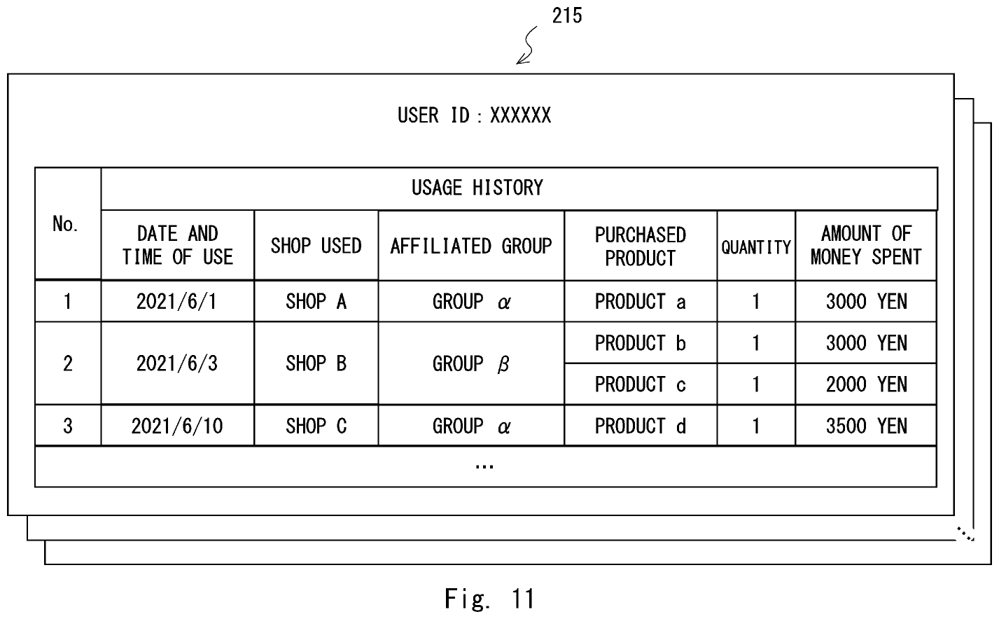

Returning to FIG. 9, the description will be continued. The usage history DB 215 stores a usage history of the user at one or a plurality of shops. The usage history DB 215 stores the user ID 2151 and the usage history 2152 in association with each other. Here, a specific example of the usage history DB 215 will be described with reference to FIG. 11.

FIG. 11 is a diagram showing an example of a data structure of the usage history DB 215 according to the second example embodiment. The usage history DB 215 is recorded with a usage history of the user for each user ID. For example, the usage history includes the date and time of use, the shop used, the affiliated group of the shop used, the purchased product (or the service used), the quantity, and the amount of money spent.

Note that the usage history of the user may be included in the user information.

Returning to FIG. 9, the description will be continued. The memory 220 is a volatile storage apparatus such as a RAM (Random Access Memory), and is a storage region for temporarily retaining information at the time of operation of the control unit 240. The communication unit 230 is a communication interface with the network N.

The control unit 240 is a process, that is, a control apparatus that controls each of the components of the server 200. The control unit 240 causes the memory 220 to read the program 211 from the storage unit 210 and executes the program 211. Thus, the control unit 240 realizes functions of a user information registration unit 241, an image acquisition unit 242, a user specifying unit 243, a usage history extraction unit 244, a first selection unit 245, an output control unit 246, and a usage history registration unit 247.

The user information registration unit 241 is also called user information registration means. Upon receiving the registered image from the user terminal 300, the user information registration unit 241 transmits a face registration request to the face authentication apparatus 100. Then, when the face authentication apparatus 100 registers the facial information and issues a user ID, the user information registration unit 241 registers the user ID in the user DB 212. In addition, upon receiving the member registration request from the user terminal 300, the user information registration unit 241 registers user information of the user in the user DB 212 in association with the user ID of the user used by the user terminal 300.

The image acquisition unit 242 is also called image acquisition means. Upon receiving the information provision request or the face payment request from the shop terminal 400, the image acquisition unit 242 acquires a facial image or facial feature information included in the request. The image acquisition unit 242 supplies the facial image or the facial feature information to the user specifying unit 243.

The user specifying unit 243 is also called user specifying means. The user specifying unit 243 controls face authentication for the facial region of the user U included in the facial image, and specifies the user. In other words, the user specifying unit 243 causes the face authentication apparatus 100 to perform face authentication on the facial image acquired from the shop terminal 400. For example, the user specifying unit 243 transmits a face authentication request including the acquired facial image to the face authentication apparatus 100 via the network N. The user specifying unit 243 may extract the facial region of the user U from the facial image, and include the extracted image in the face authentication request. Further, the user specifying unit 243 may extract facial feature information from the facial region, and include the facial feature information in the face authentication request. Then, the user specifying unit 243 receives the result of face authentication from the face authentication apparatus 100. Thus, the user specifying unit 243 specifies the user ID of the user.

The usage history extraction unit 244 is also called usage history extraction means. Upon receiving the information provision request from the shop terminal 400, the usage history extraction unit 244 extracts the usage history associated with the user ID specified by the user specifying unit 243, from the usage history DB 215. The usage history extraction unit 244 supplies the extracted usage history to the first selection unit 245.

The first selection unit 245 is also called first selection means. The first selection unit 245 selects, as a recommended shop, at least one shop from a plurality of shops, based on the affiliated group 2132 of the shop information DB 213 and the relation information 214. For example, the first selection unit 245 may select, as a recommended shop, a shop that belongs to a group whose degree of relationship with the affiliated group of the shop (first shop) visited by the user is equal to or greater than a predetermined threshold. Further, for example, the first selection unit 245 may select, as recommended shops, shops that belong to groups whose degree of relationship with the affiliated group of the first shop is within the top n-rank (n being a preset natural number). The recommended shop may or may not be selected to include the first shop. In addition, the business operated by the recommended shop may be the same as or different from that of the first shop. Meaning that the businesses to be operated are different from each other indicates that business fields are different from each other in light of predetermined criteria, and may include, for example, a case where the first shop operates a cosmetics sales business and a case where the recommended shop operates a restaurant business. When shops with different types of businesses are selected as recommended shops, users can be widely guided to services in other fields of the company's own group or alliance groups. Therefore, it is possible to encourage the user to visit all of the groups.

Then, the first selection unit 245 selects, as recommended sales promotion information, at least one sales promotion information from a plurality of pieces of sales promotion information related to the recommended shop. For example, the first selection unit 245 selects recommended sales promotion information from the plurality of pieces of sales promotion information associated with the shop ID of the recommended shop in the shop information DB 213. The recommended sales promotion information may be selected based on at least one of the user information associated with the user ID in the user DB 212 and the usage history associated with the user ID in the usage history DB 215.

The first selection unit 245 may adjust the quantity or quality of the recommended sales promotion information to be selected, based on a usage history of a specified user at shops of the affiliated group of the alliance group. For example, the first selection unit 245 may adjust the quantity or quality of the recommended sales promotion information, based on the amount of money spent in the affiliated group of the first shop by the specified user, or a visiting frequency of the user to the shop belonging to the affiliated group. As an example, as the amount of money spent or the visiting frequency increases, the first selection unit 245 may increase the amount of recommended sales promotion information, select sales promotion information with high discount rate, or preferentially select sales promotion information including discount information. Thus, for example, as the user purchases products more and more at the shops in the affiliated group or visits the shops more and more, information useful to the user can be obtained. Therefore, it becomes easier for the shop to guide the user into the affiliated group of the shop.

The output control unit 246 is also called output control means. In the present second example embodiment, the output control unit 246 transmits the sales promotion information selected by the first selection unit 245 to the shop terminal 400 of the first shop visited by the user, and causes the shop terminal 400 to display the information.

The usage history registration unit 247 is also called usage history registration means. When the specified user uses the shop, the usage history registration unit 247 registers use information related to the use in the usage history DB in association with the user ID. For example, upon receiving the face payment request from the shop terminal 400, the usage history registration unit 247 registers, as a usage history, use information related to payment included in the face payment request in the usage history DB 215 in association with the user ID.

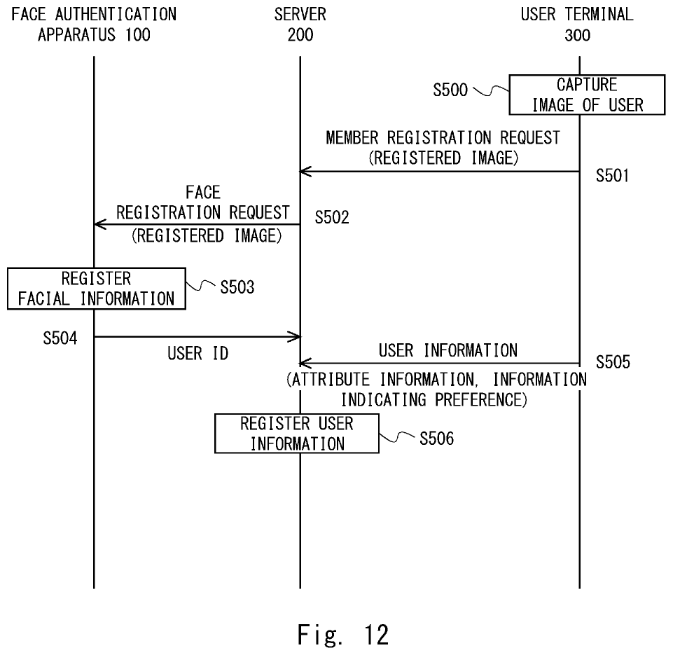

FIG. 12 is a sequence diagram showing a flow of member registration processing according to the second example embodiment. First, the user terminal 300 captures an image of the user U (S500), and transmits a member registration request including a registered image generated by the capturing to the server 200 (S501). Then, the user information registration unit 241 of the server 200 transmits the face registration request including the registered image included in the received member registration request to the face authentication apparatus 100 (S502). Then, the face authentication apparatus 100 registers facial information (facial feature information) of the user U based on the registered image included in the received face registration request (S503). Then, the face authentication apparatus 100 notifies the server 200 of the issued user ID (S504). In addition, the user terminal 300 receives the input of the user information from the user, and transmits the user information to the server 200 (S505). The user information transmitted here includes attribute information of the user and information indicating preference of the user. The user information registration unit 241 of the server 200 registers the notified user ID and the user information in the user DB 212 in association with each other (S506).

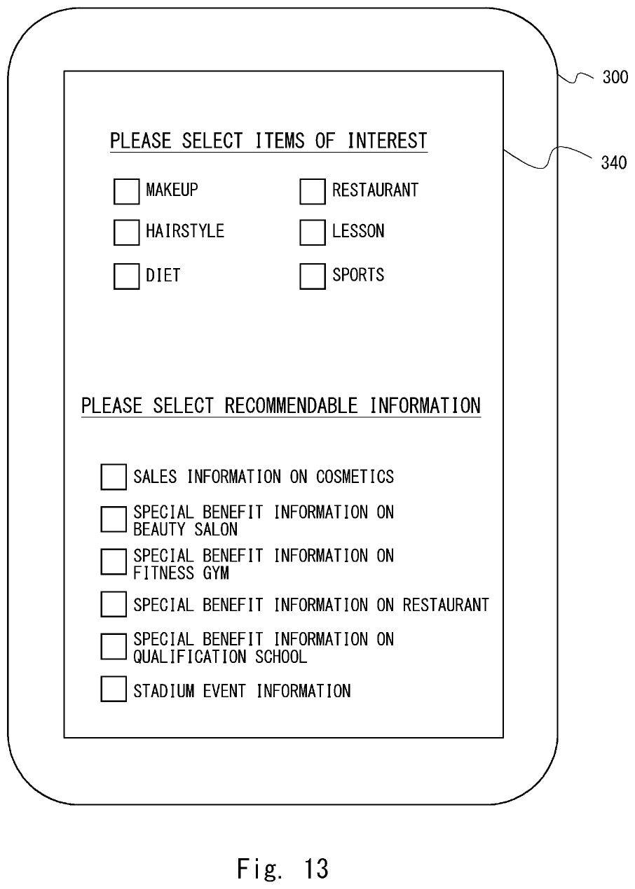

FIG. 13 is a diagram showing an example of a display on the user terminal 300 according to the second example embodiment. FIG. 13 shows an input screen of the user information displayed on the display unit 340 of the user terminal 300 at the time of member registration. The screen in FIG. 13 includes, as input regions for information indicating preference of the user, an input region for selecting items of interest to the user and an input region for selecting recommendable information. For example, the user selects “makeup” and “restaurant” as items of interest, and selects “sales information on cosmetics” and “special benefit information on restaurant” as recommendable information. In S505, the user terminal 300 transmits the information received from each of the input regions to the server 200, as information indicating the preference of the user.

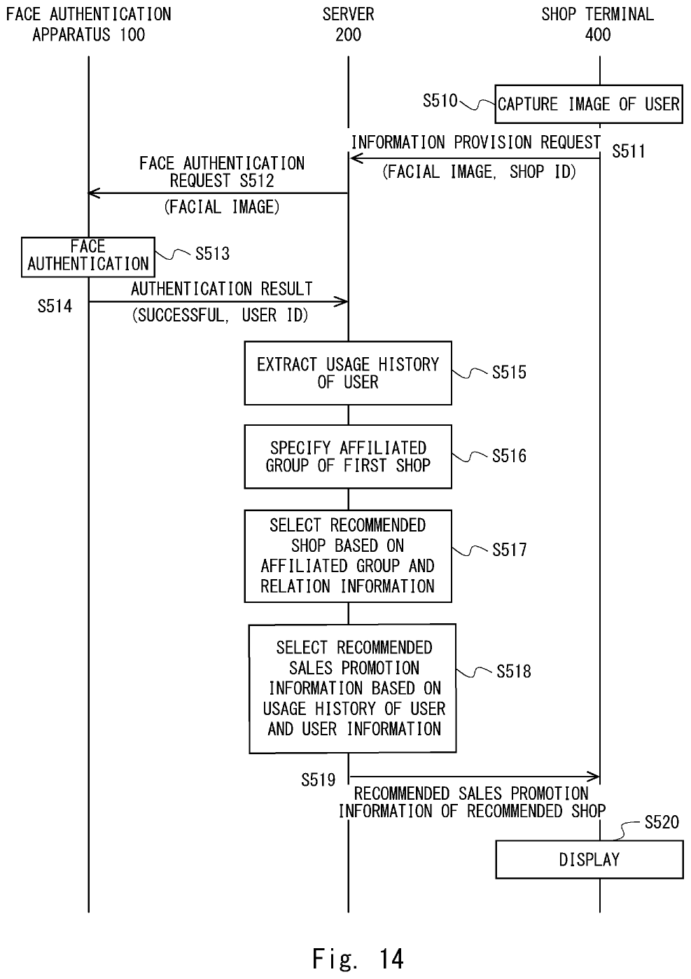

FIG. 14 is a sequence diagram showing a flow of information provision processing according to the second example embodiment. First, the shop terminal 400 of the first shop captures an image of the user who visits the first shop (S510). Then, the shop terminal 400 transmits an information provision request to the server 200 (S511). The information provision request includes a facial image generated by the capturing and a shop ID for identifying the first shop. Thereby, the image acquisition unit 242 of the server 200 acquires the facial image of the user. Next, the user specifying unit 243 of the server 200 transmits a face authentication request for the facial region of the user U in the facial image to the face authentication apparatus 100 (S512). Then, the face authentication apparatus 100 performs face authentication on the facial region of the user U in the facial image included in the received face authentication request (S513). Here, it is assumed that there is a user ID for which the face authentication has succeeded. The face authentication apparatus 100 transmits a face authentication result including the fact that the face authentication is successful and the user ID, to the server 200 (S514). The user specifying unit 243 of the server 200 specifies the user based on the user ID included in the face authentication result.

Next, the usage history extraction unit 244 of the server 200 extracts the usage history associated with the user ID included in the face authentication result, from the usage history DB 215 (S515), and supplies the extracted usage history to the first selection unit 245. Next, the first selection unit 245 specifies the affiliated group of the first shop by referring to the shop information DB 213 using the shop ID for identifying the first shop (S516). Next, the first selection unit 245 selects a recommended shop from a plurality of shops based on the specified affiliated group and the relation information 214 (S517). Next, the first selection unit 245 selects, based on the usage history of the user extracted in S515 and the user information associated with the user ID in the user DB 212, recommended sales promotion information from the sales promotion information of the recommended shop stored in the shop information DB 213 (S518). Next, the output control unit 246 transmits the recommended sales promotion information of the recommended shop to the shop terminal 400 of the first shop (S519). The shop terminal 400 displays the recommended sales promotion information of the recommended shop on the display unit 440 (S520).

In the above description, in S517, the affiliated group and the relation information 214 are used as a basis of selection of the recommended shop, and the usage history and the user information are used as a basis of selection of the recommended sales promotion information, but the present invention is not limited thereto. For example, additionally or alternatively, the usage history and the user information may be used as a basis of selection of the recommended shop. As an example, when the first shop provides vehicle sales and vehicle maintenance services, the first selection unit 245 may select a recommended shop based on the maintenance history of the vehicle of the user, which is included in the usage history of the user, from the shops specified based on the affiliated group and the relation information 214 of the first shop. Then, the first selection unit 245 may select, based on the usage history and the user information, sales promotion information of the user's taste service from the sales promotion information of the recommended shop.

In addition, the affiliated group and the relation information 214 may be used as a basis of selection of the recommended sales promotion information. For example, the first selection unit 245 may select a recommended product or a recommended service from the usage history and the user information, and select sales promotion information of the recommended shop from sales promotion information about the recommended product or the recommended service, based on the affiliated group and the relation information 214. As an example, when the first shop provides vehicle sales and vehicle maintenance services, first, the first selection unit 245 may select a type of necessary maintenance service based on the maintenance history of the vehicle of the user which is included in the usage history of the user. Then, the first selection unit 245 may select, as the recommended sales promotion information of the recommended shop, sales promotion information of the shop having a high degree of relationship with the affiliated group of the first shop, from the sales promotion information related to the selected maintenance service.

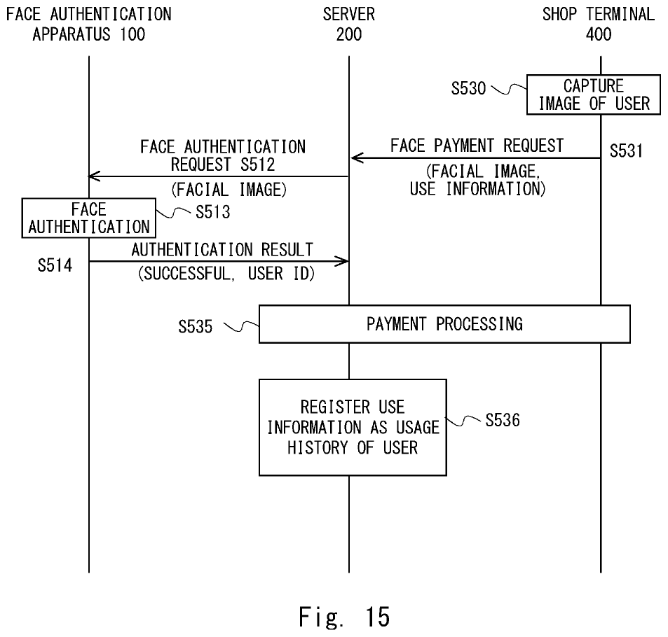

FIG. 15 is a sequence diagram showing a flow of usage history registration processing according to the second example embodiment. First, the shop terminal 400 of the first shop captures an image of the user when the user performs face payment for use of the first shop (S530). Next, the shop terminal 400 transmits a face payment request to the server 200 (S531). The face payment request may include a facial image generated by the capturing and use information related to the face payment. Then, processes of S512 to S514 are executed in the information processing system 1000.

The usage history registration unit 247 of the server 200, which has received the face authentication result, executes payment processing with the shop terminal 400 (S535). At this time, the usage history registration unit 247 of the server 200 designates a billing destination as the user. Then, the usage history registration unit 247 of the server 200 registers the use information as a usage history in the usage history DB 215 in association with the user ID included in the face authentication result (S536).

The information provision request in S511 of FIG. 14 and the face payment request in S531 of FIG. 15 may include the facial image of the user captured at the same timing, or may use the face authentication result. Alternatively, in S511 of FIG. 14, the shop terminal 400 may perform the face payment request together with the information provision request. In this case, some or all of S530 to S531 in FIGS. 15 and S512 to S514 in FIG. 15 may be omitted. Thus, various effects can be obtained that a processing load of the information processing system 1000 is reduced to save a trouble of capturing the image of the user's face and an increase in a psychological burden of the for capturing is reduced.

According to the second example embodiment as described above, the server 200 personalizes the sales promotion information of the shop having a business relationship with the first shop based on the attribute and the preference of the user, and provides the personalized sales promotion information to the user who visits the first shop. Therefore, it becomes easier to encourage the users to visit the company's own group or the alliance group of the shops visited while increasing satisfaction of the users, whereby customer retention can be easily made.

In the second example embodiment, the first selection unit 245 may select the recommended sales promotion information related to the recommended shop, based on a use cycle of products or services used by the user in addition to the user information and the usage history. The use cycle may be referred to as a purchase cycle.

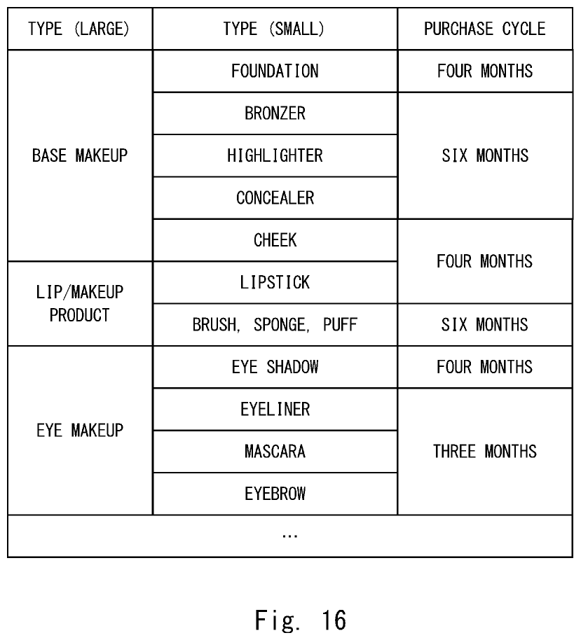

FIG. 16 is a diagram for explaining the purchase cycle according to the second example embodiment. The purchase cycle may be decided in advance according to a type of product or a type of service. FIG. 16 shows an example of a purchase cycle when the first shop visited by the user is a shop that sell cosmetics and the server 200 recommends cosmetics to the user. The type of product (cosmetics) may be divided into major items and minor items representing the purpose of use or the site of use, and the purchase cycle may be decided based on at least one of the major items and the minor items. As an example, the purchase cycle of a product whose major item is “base makeup” and minor item is “foundation” is “four months”. On the other hand, the purchase cycle of a product whose major item is “eye makeup” and minor item is “eyeliner”, “mascara”, or “eyebrow” is “three months”.

For example, when the user purchases an eyeliner, whose purchase cycle is three months, three months ago, the first selection unit 245 decides the type of product to be proposed as “eyeliner”. For example, when the user purchases an eyeliner, whose purchase cycle is three months, three months ago, the first selection unit 245 may decide the major item “eye makeup” to which the minor item “eyeliner” belongs, as the type of product to be proposed.

Then, the first selection unit 245 selects, as recommended sales promotion information, sales promotion information about the eyeliner from sales promotion information regarding various products of the recommended shop. The sales promotion information about the eyeliner may be, for example, information about a new eyeliner product, word-to-mouth information, or discount information. Before selecting the recommended sales promotion information, the first selection unit 245 may select, as a recommended shop, a shop related to a cosmetics sales business in the same affiliated group as the visited shop from shops having the sales promotion information about the eyeliner. In this way, the first selection unit 245 determines the type of product to be proposed, based on the purchase cycle and the timing of the previous purchase, and selects the recommended sales promotion information based on the determined type of product. Thus, the server 200 can provide information adapted to the purchase cycle of the user for each type of product. The server 200 may transmit the recommended sales promotion information to the shop terminal 400 or the user terminal 300 when the user visits the first shop, or may transmit the recommended sales promotion information to the user terminal 300 regardless of whether the user visits the shop.

In addition, when selecting the recommended shop and the recommended sales promotion information, the first selection unit 245 may select the recommended shop and the recommended sales promotion information, based on sale information of each shop instead of or in addition to the use cycle.

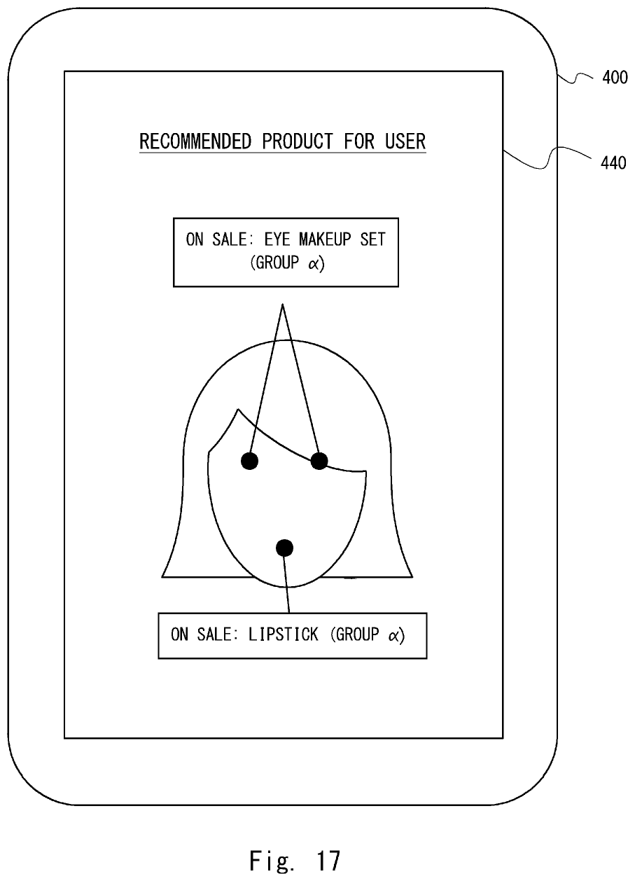

Upon receiving such recommended sales promotion information, the shop terminal 400 may display a screen shown in FIG. 17 on the display unit 440. FIG. 17 is a diagram showing an example of a display on the shop terminal 400 according to a fourth example embodiment. The display unit 440 displays information about eye makeup sets and lipsticks that are on sale at a shop of a group a as products to be recommended to the user.

Thereby, products or services on sale are preferentially introduced to the user.

In FIG. 17, an illustration of a person's face is displayed on the display unit 440, and information about a product is displayed in the person's face at a position corresponding to the use site of the product. The illustration of the person's face may be a registered image of the user or a facial image of the user at the time of face authentication.

In the examples of FIGS. 16 and 17 described above, a case has been described in which the sales promotion information of the shop executing the cosmetics sales service is provided, but the business field of the shop is not limited thereto. For example, when sales promotion information for a shop executing a vehicle maintenance service is provided, the first selection unit 245 may determine a type of maintenance (for example, change of engine oil or change of tires) based on the timing of vehicle purchase or previous maintenance and the maintenance cycle. Then, the first selection unit 245 may select recommended sales promotion information based on the determined type of maintenance.

### Third Example Embodiment

A third example embodiment of the present disclosure will be described below. The third example embodiment is characterized in that the server provides appropriate sales promotion information in consideration of an opportunity loss of the user.

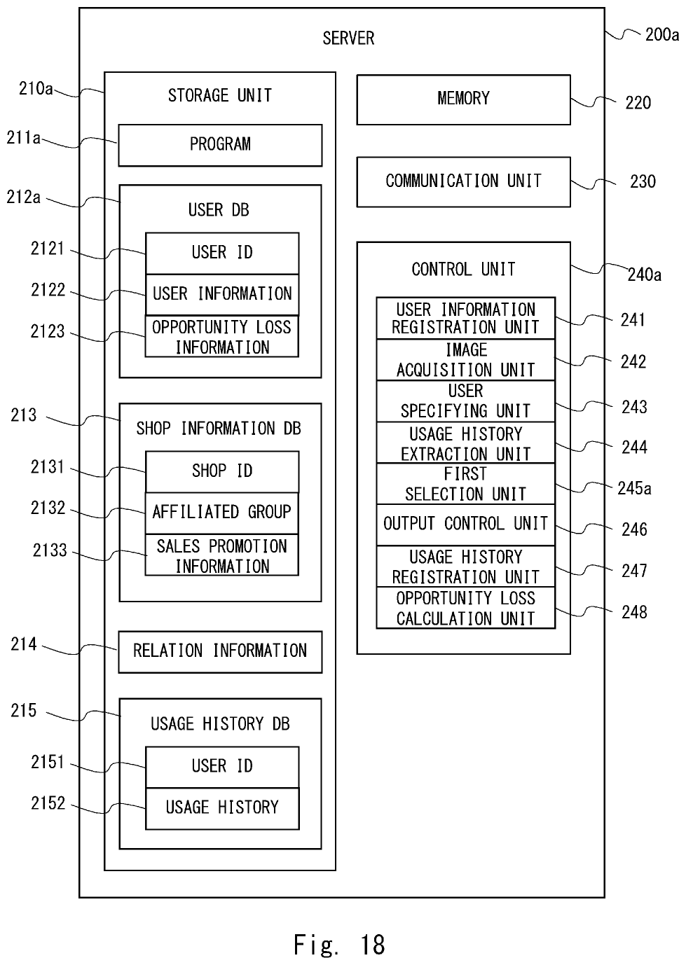

FIG. 18 is a block diagram showing a configuration of a server 200a according to the third example embodiment. The server 200a has basically the same configuration and functions as the server 200. However, the server 200a differs from the server 200 in that a storage unit 210a and a control unit 240a are provided instead of the storage unit 210 and the control unit 240.

The storage unit 210a stores a program 211a instead of the program 211 and a user DB 212a instead of the user DB 212. The program 211a is a computer program in which processing of an information processing method according to the third example embodiment is implemented.

The user DB 212a further stores opportunity loss information 2123 in association with the user ID 2121. The opportunity loss information 2123 is information indicating that the user has visited a predetermined shop but has not used the shop. For example, the opportunity loss information may indicate an opportunity loss rate obtained by dividing the number of times of use of the predetermined shop by the number of times of visiting of the predetermined shop. Further, for example, the opportunity loss information may indicate an opportunity loss rate when the user visiting the shop is specified but the fact is not recorded that the user has used the shop at the time of visiting.

Here, various methods may be taken as a method of specifying a user who has visited the shop. In the present third example embodiment, “Method 1” below is adopted, but “Method 2” or “Method 3” may be adopted without being limited thereto.

### Method 1

For example, when the user visits the first shop, the user terminal 300 is configured to transmit the facial image of the user captured in advance or the facial feature information to the shop terminal 400 by short-range wireless communication. The short-range wireless communication may be Bluetooth (registered trademark) or BLE (Bluetooth Low Energy). Then, the shop terminal 400 transmits a shop visit record request including the acquired facial image or facial feature information to the server 200. The server 200a controls the face authentication apparatus 100 to perform face authentication based on the facial region of the user, thereby specifying the user who has visited the shop.

### Method 2

When the user visits the first shop, the user terminal 300 may be configured to transmit the user ID registered in the user terminal 300 in advance to the shop terminal 400 by short-range wireless communication. In this case, the shop terminal 400 transmits a shop visit record request including the user ID to the server 200a, whereby the server 200a specifies the user who has visited the shop.

### Method 3

The server 200a may specify the user who has visited the shop by face authentication using the camera 410 of the shop terminal 400, similar to the face authentication at the time of information provision or face payment. The camera 410 of the shop terminal 400 at this time may be installed in a place other than a cash register of the shop.

In a case of adopting “Method 1”, “Method 2”, or “Method 3”, it is possible to record the fact that the user has visited the shop even when the user does not visit the cash register of the shop, and thus the opportunity loss can be easily calculated.

The control unit 240a includes an opportunity loss calculation unit 248 and a first selection unit 245a instead of the first selection unit 245.

The opportunity loss calculation unit 248 is also called opportunity loss calculation means. First, the opportunity loss calculation unit 248 acquires, from the shop visit record request, shop visit information indicating that the user has visited the first shop. The shop visit information may include a user ID, information on visit date and time of the user, and a visited shop ID.

In a case of adopting “Method 1” or “Method 3”, the shop visit record request may include a facial image or facial feature information, information on visit date and time of the user, and a visited shop ID. In this case, the opportunity loss calculation unit 248 specifies the user ID included in the shop visit information, from the result of face authentication based on the facial region of the user, and generates shop visit information by matching the user ID with the information on visit date and time and the visited shop ID. On the other hand, in a case of adopting “Method 2”, the shop visit record request may include the user ID, the information on visit date and time of the user, and the visited shop ID. Then, the opportunity loss calculation unit 248 acquires the shop visit record request as it is as shop visit information.

The opportunity loss calculation unit 248 may store the shop visit information as a shop visit history in the storage unit 210a in association with the user. The shop visit history may be information included in the user information of the user DB 212.

Then, the opportunity loss calculation unit 248 generates opportunity loss information from the shop visit history and usage history of the user. For le, the opportunity loss calculation unit 248 calculates a number of times of visiting of the predetermined shop (number of times of visiting) and a number of times of use of the predetermined shop (number of times of use). The number of times of use may simply be the number of times of usage history relating to the predetermined shop, or may be the number of times of usage history recorded as being used within a predetermined period of time from the shop visit time of the user. Then, the opportunity loss calculation unit 248 generates opportunity loss information of the user based on the number of times of visiting and the number of times of use. The opportunity loss calculation unit 248 registers the generated opportunity loss information in the user DB 212 in association with the user ID.

The first selection unit 245a selects recommended sales promotion information related to the recommended shop, based on the opportunity loss information of the user in addition to the user information, the usage history of the user, and the relation information 214. For example, for a user whose number of times of visiting of a specified shop is many but number of times of use is less, it is considered that the user is interested in a product or service of the shop but has not yet purchased the product or service. Therefore, the first selection unit 245a may preferentially select, as recommended sales promotion information, discount information that encourages purchase of the product of the specified shop. For example, for a user whose total number of times of visiting of a plurality of shops is many but total number of times of use is less, it is considered that the user has a personality of wanting to carefully examine contents of the product before purchasing. Therefore, the first selection unit 245a may preferentially select, as recommended sales promotion information, detailed information about the product of interest of the user.

In this way, the first selection unit 245a analyzes situation and personality of the user based on the opportunity loss information to utilize for selection of the sales promotion information to be provided, whereby the server 200a can provide sales promotion information effective for customer retention.

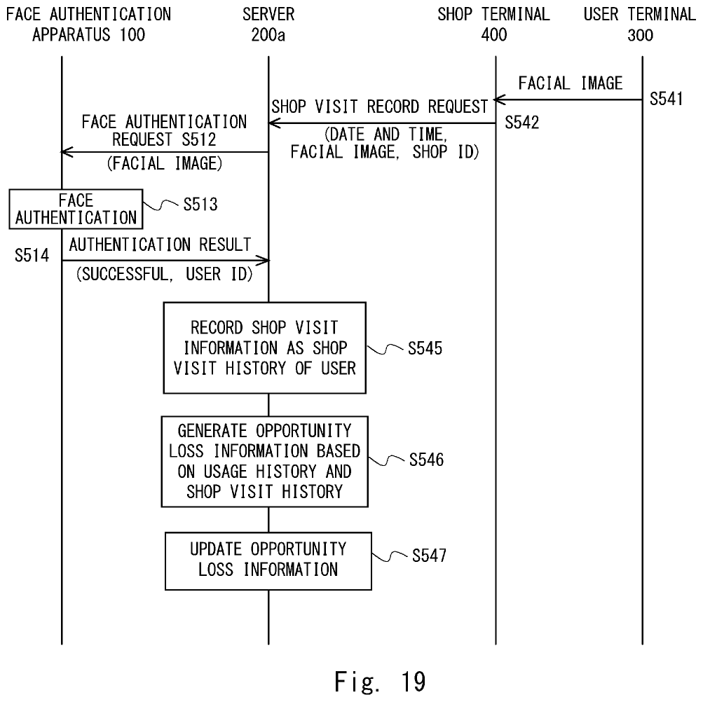

Here, opportunity loss calculation processing by the opportunity loss calculation unit 248 will be described. FIG. 19 is a sequence diagram showing a flow of opportunity loss calculation processing according to the third example embodiment. First, when the user visits the first shop, the user terminal 300 transmits the facial image of the user, which is stored in advance in the storage unit 320 of the user terminal 300, to the shop terminal 400 by short-range wireless communication (S541).

In response to receiving the facial image of the user from the user terminal 300, the shop terminal 400 transmits a shop visit record request to the server 200a (S542). The shop visit record request may include a visiting date and time, a facial image of the user, and a shop ID.

When the server 200a receives the shop visit record request, the same processes as S512 to S514 are executed. Thus, since the opportunity loss calculation unit 248 of the server 200a specifies the user ID, the shop visit information including the user ID, the visiting date and time, and the shop ID can be acquired.

The opportunity loss calculation unit 248 of the server 200a, which has received the face authentication result, records the shop visit information as a shop visit history of the user in the user DB 212 (S545). The opportunity loss calculation unit 248 generates opportunity loss information based on the usage history of the usage history DB 215 and the shop visit history of the user DB 212 (S546). Then, the opportunity loss calculation unit 248 updates the opportunity loss information corresponding to the user ID in the user DB 212 (S547).

### Fourth Example Embodiment

A fourth example embodiment of the present disclosure will be described below. In the fourth example embodiment, the first shop visited by the user is a shop that provides services related to beauty, for example, a shop that sells cosmetics. In the fourth example embodiment, the server personalizes information about cosmetics products or special benefit information about cosmetics products, and then provides such information as recommended sales promotion information to the user.

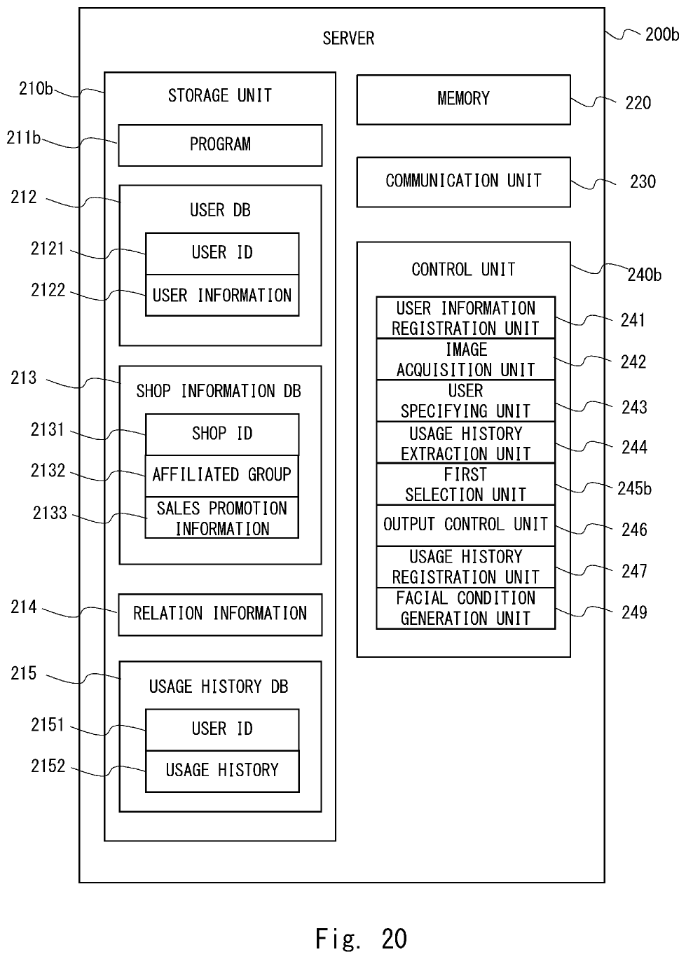

FIG. 20 is a block diagram showing a configuration of a server 200b according to the fourth example embodiment. The server 200b differs from the server 200 in that a storage unit 210b and a control unit 240b are provided instead of the storage unit 210 and the control unit 240.

The storage unit 210b stores a program 211b instead of the program 211. The program 211b is a computer program in which processing of an information processing method according to the fourth example embodiment is implemented.

The control unit 240b includes a facial condition generation unit 249 and a first selection unit 245b instead of the first selection unit 245.

The facial condition generation unit 249 is also called facial condition generation means. The facial condition generation unit 249 generates facial condition information from the facial image of the user acquired by the image acquisition unit 242. The facial condition information is information about the facial condition of the user, and includes information about a skin color, a skin moisture content, a pore condition, or a skeleton, for example. The facial image of the user used for generating the facial condition information is also used for face authentication to specify the user.

The first selection unit 245b selects recommended sales promotion information related to a recommended shop, based on the facial condition information generated by the facial condition generation unit 249 in addition to the user information, the usage history, and the relation information 214.

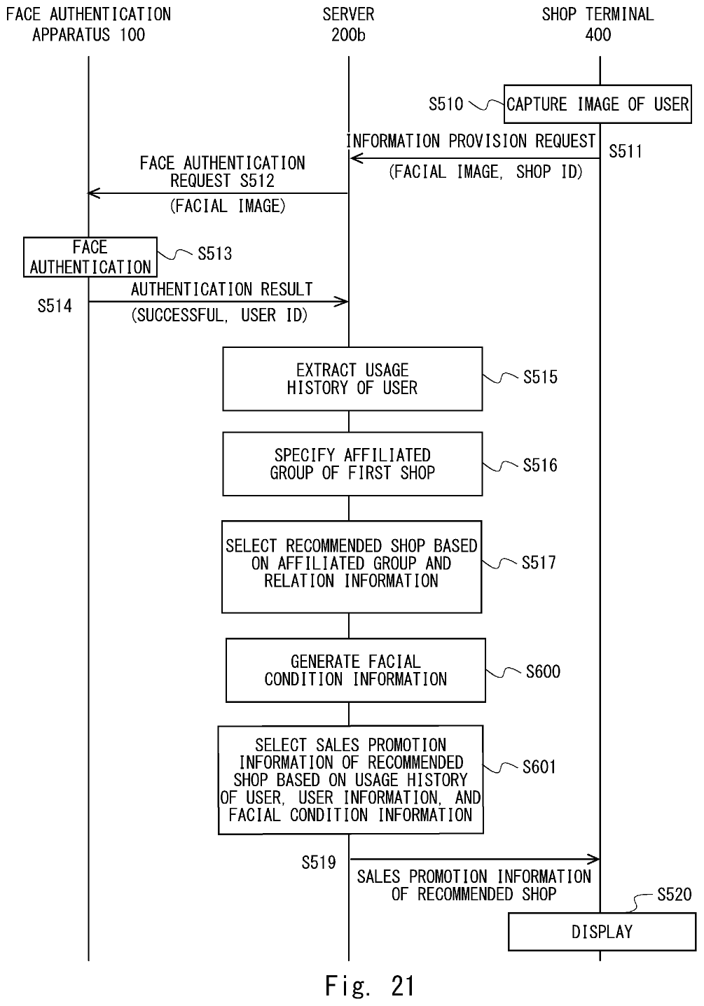

FIG. 21 is a sequence diagram showing a flow of information provision processing according to the fourth example embodiment. Steps shown in FIG. 21 include S600 and S601 instead of S518 shown in FIG. 14.

In S600, the facial condition generation unit 249 of the server 200b generates facial condition information based on the facial image included in the information provision request acquired in S511. The facial condition generation unit 249 supplies the facial condition information to the first selection unit 245b.

Next, the first selection unit 245b of the server 200b selects recommended sales promotion information from the sales promotion information of the recommended shop stored in the shop information DB 213 (S601). At this time, the facial condition information is used as a basis for selection in addition to the usage history of the user extracted in S515 and the user information associated with the user ID in the user DB 212. Next, the output control unit 246 transmits the recommended sales promotion information of the recommended shop to the shop terminal 400 of the first shop (S519). The shop terminal 400 displays the recommended sales promotion information of the recommended shop on the display unit 440 (S520).

In the above description, the facial condition information is used as a basis for selection of the recommended sales promotion information, but the facial condition information may alternatively or additionally be used as a basis for selection of the recommended shop.

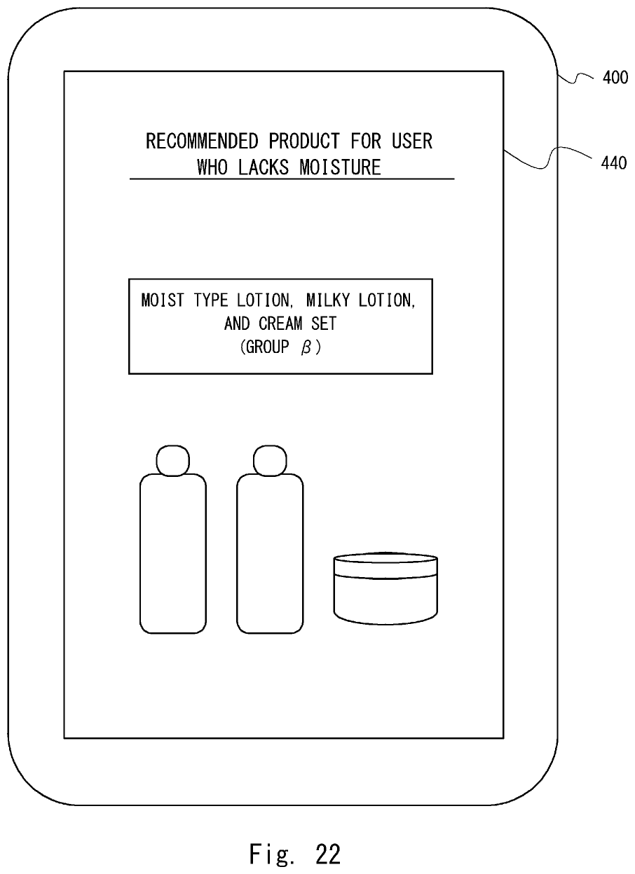

FIG. 22 is a diagram showing an example of a display on the shop terminal 400 according to the fourth example embodiment. For example, the facial condition generation unit 249 generates facial condition information indicating that the skin has a low moisture content and is dry, based on the texture and color of the user's skin. Then, the first selection unit 245b selects, as recommended sales promotion information, information about products with a high moisturizing effect sold by shops belonging to the affiliated group or alliance group of the first shop. Then, the shop terminal 400 displays the recommended sales promotion information on the display unit 440. In FIG. 22, the shop terminal 400 displays information about a moist-type cosmetics set as a cosmetics set belonging to a group β affiliated with a group a which is the affiliated group of the first shop, on the display unit 440.

In this way, the server 200b uses the facial image for face authentication to grasp the current condition of the user's face, and uses the current condition of the user's face to select information to be provided. Therefore, the server 200b can provide appropriate information adapted to the situation of the user, whereby the satisfaction of the user is improved. Thus, user retention can be easily made.

### Fifth Example Embodiment

Next, a fifth example embodiment of the present disclosure will be described. In the fifth example embodiment, the first shop visited by the user is a shop that provides vehicle services, for example, a shop that sells vehicles.

The server personalizes information about vehicle services or special benefit information about vehicle services, and then provides such information to the user. In the fifth example embodiment, the server transmits information about a shop capable of performing maintenance to the user terminal regardless of whether the user visits the first shop when receiving a request for maintenance from the user terminal. Thus, for example, when a vehicle breaks down during moving, the user can easily know the existence of a nearby shop where maintenance can be performed. In addition, for example, when the user moves to another house after purchase of a vehicle, the user can easily know a shop, where maintenance can be performed maintenance, near the user's house.

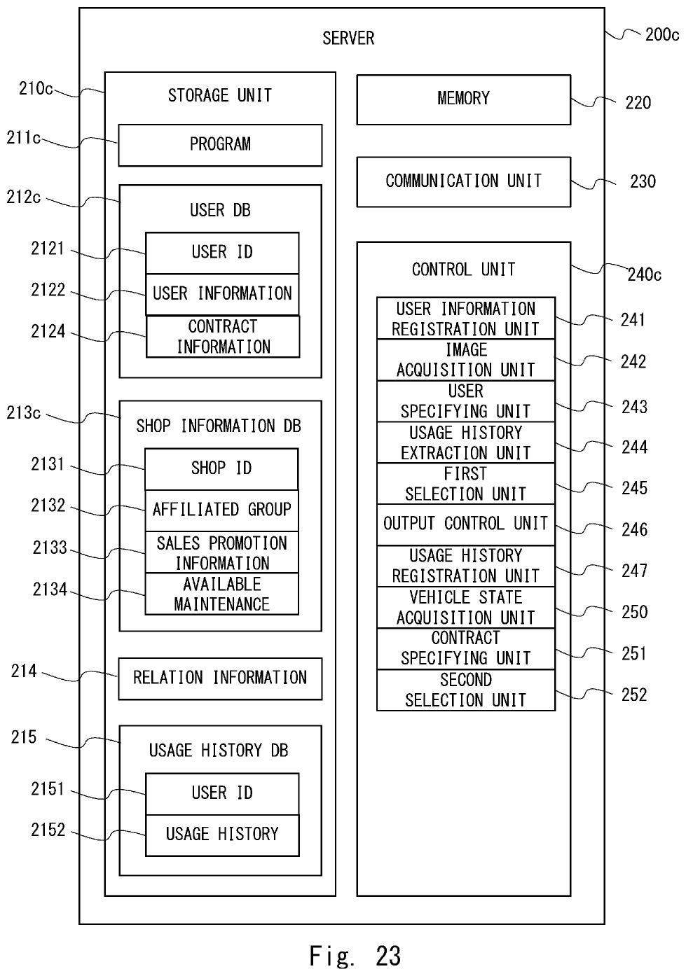

FIG. 23 is a block diagram showing a configuration of a server 200c according to the fifth example embodiment. The server 200c has basically the same configuration and functions as the server 200. However, the server 200c differs from the server 200 in that a storage unit 210c and a control unit 240c are provided instead of the storage unit 210 and the control unit 240.

The storage unit 210c stores a program 211c, a user DB 212c, and a shop information DB 213c instead of the program 211, the user DB 212, and the shop information DB 213. The program 211c is a computer program in which processing of information processing method according to the fifth example embodiment is implemented. The user DB 212c further stores contract information 2124 in association with the user ID 2121.

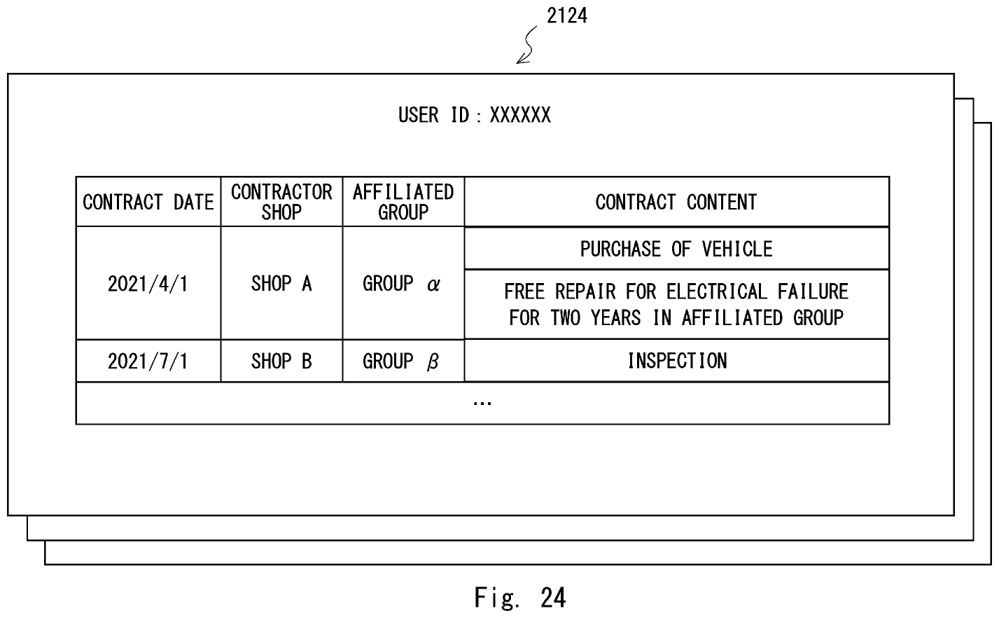

The contract information 2124 is information about a user's vehicle-related contract into which the user enters. FIG. 24 is a diagram showing an example of a data structure of the contract information 2124 according to the fifth example embodiment. The contract information 2124 is recorded with contract information of the user for each user ID. For example, the contract information includes a contract date, a contractor shop, an affiliated group, and contract contents. As an example, a user's record on Apr. 1, 2021 is recorded with a fact of purchasing a vehicle at a shop A belonging to a group a and a fact that there is a benefit of free repairs for electrical failures for two years when the shop belongs to the affiliated group α.

Returning to FIG. 23, the description will be continued. The shop information DB 213c further stores available maintenance 2134 in association with the shop ID 2131. The available maintenance 2134 indicates a type of maintenance that the shop can be currently available based on inventory information about prats at the shop and availability of working hours.

The control unit 240c includes a vehicle state acquisition unit 250, a contract specifying unit 251, and a second selection unit 252 in addition to the configuration of the control unit 240.

The vehicle state acquisition unit 250 is also called vehicle state acquisition means. The vehicle state acquisition unit 250 receives a maintenance request for a vehicle from the user terminal 300. For the maintenance request, user's personal identification information, user's vehicle state information, and user's position information are acquired. As described above, the vehicle state information may indicate, for example, a specific site of the vehicle has failed, that a specific function is not operated, or that a specific function is malfunctioning. The vehicle state acquisition unit 250 supplies the vehicle state information and the user's position information to the second selection unit 252.

In the present fifth example embodiment, the personal identification information is the facial image or facial feature information of the user, but may alternatively be a user ID. When the personal identification information is the facial image or facial feature information, the vehicle state acquisition unit 250 supplies the personal identification information to the user specifying unit 243. Thus, the user specifying unit 243 controls face authentication to specify the user. The contract specifying unit 251 is also called contract specifying means.

When the user specifying unit 243 specifies the user who requests for maintenance, the contract specifying unit 251 specifies contract information. Then, the contract specifying unit 251 specifies a contractor shop included in the contract information.

The second selection unit 252 is also called second selection means. The second selection unit 252 selects, as a recommended shop, at least one shop from candidate shops, which are shops capable of performing maintenance corresponding to the vehicle state.

For example, first, the second selection unit 252 specifies a type of maintenance based on the vehicle state information.

Next, the second selection unit 252 determines whether each of a plurality of shops performs maintenance corresponding to the vehicle state based on the available maintenance 2134 registered in the shop information DB 213c. In other words, the second selection unit 252 specifies a candidate shop that can perform maintenance corresponding to the vehicle state based on inventory information about prats adapted to the type of maintenance and availability of working hours.

Then, the second selection unit 252 selects a recommended shop from the candidate shops based on the information about the contractor shop, which is included in the contract information, and the user's position information. The information about the contractor shop may include at least a name of the contractor shop and position information of the contractor shop. For example, the second selection unit 252 selects a recommended shop from the candidate shops, based on relation information between each of the plurality of shops and the contractor shop and the user's position information. For example, the second selection unit 252 preferentially selects, as a recommended shop, a shop in the affiliated group or the alliance group of the contractor shop from candidate shops in the vicinity of a user's current location. Thus, when maintenance is required while user-side convenience is ensured, it is possible to promote the use of the affiliated group or the alliance group of the contractor shop with a transaction history. Therefore, user retention can be easily made.

Further, the second selection unit 252 may select the recommended shop from the candidate shops based on contract contents and user's position information in addition to or instead of the information about the contractor shop. For example, the second selection unit 252 preferentially selects, as a recommended shop, a shop, at which services or benefits decided by the contract are provided, from candidate shops in the vicinity of the user's current location. Thus, the user can easily grasp the shop that are profitable for him/herself, and thus the satisfaction of the user is improved.

Then, the output control unit 246 outputs information related to the selected recommended shop to the user terminal 300 that requests maintenance. The information related to the recommended shop may include basic information and sales promotion information about the recommended shop.

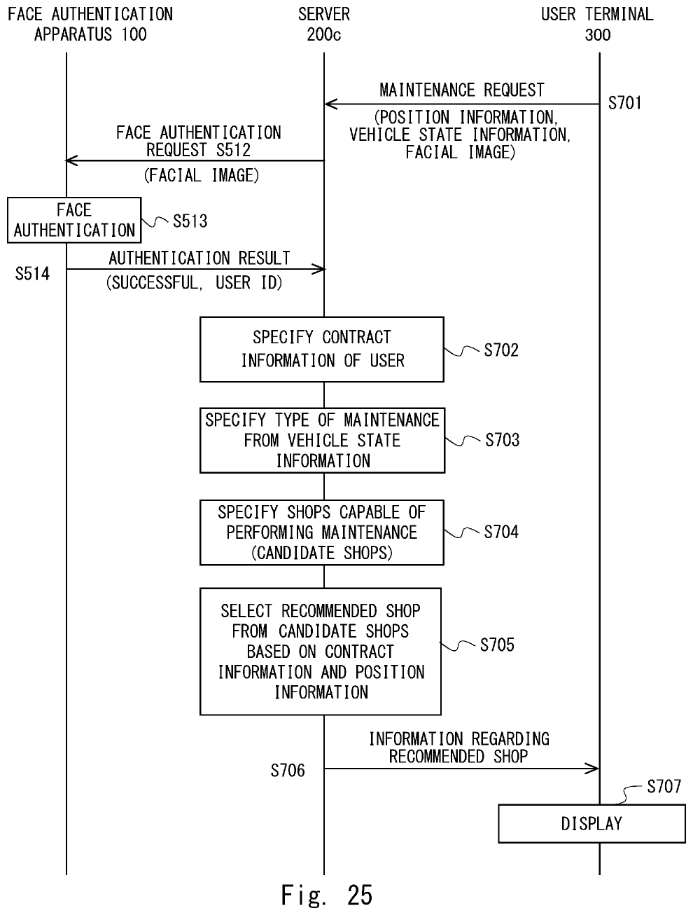

FIG. 25 is a sequence diagram showing a flow of information provision processing according to the fifth example embodiment. First, the user terminal 300 transmits a maintenance request to the server 200c (S701). The maintenance request includes the user's position information, the vehicle state information, and the facial image of the user as the personal identification information. Thus, the vehicle state acquisition unit 250 of the server 200c acquires various information included in the maintenance request. Next, the information processing system 1000 executes processes of S512 to S514. Thus, the user specifying unit 243 of the server 200c specifies the user ID of the user.

Next, the contract specifying unit 251 of the server 200c refers to the user DB 212c, and specifies the contract information 2124 associated with the user ID (S702). Next, the second selection unit 252 of the server 200c specifies the type of maintenance based on the vehicle state information (S703). Next, the second selection unit 252 specifies candidate shops capable of performing maintenance, based on the type of maintenance and the available maintenance 2134 registered in the shop information DB 213c (S704). Next, the second selection unit 252 selects a recommended shop from the candidate shops, based on at least the contract information 2124 and the position information (S705). Then, the output control unit 246 of the server 200c transmits information related to the recommended shop to the user terminal 300 (S706). The user terminal 300 displays the information related to the recommended shop on the display unit 340 (S707).

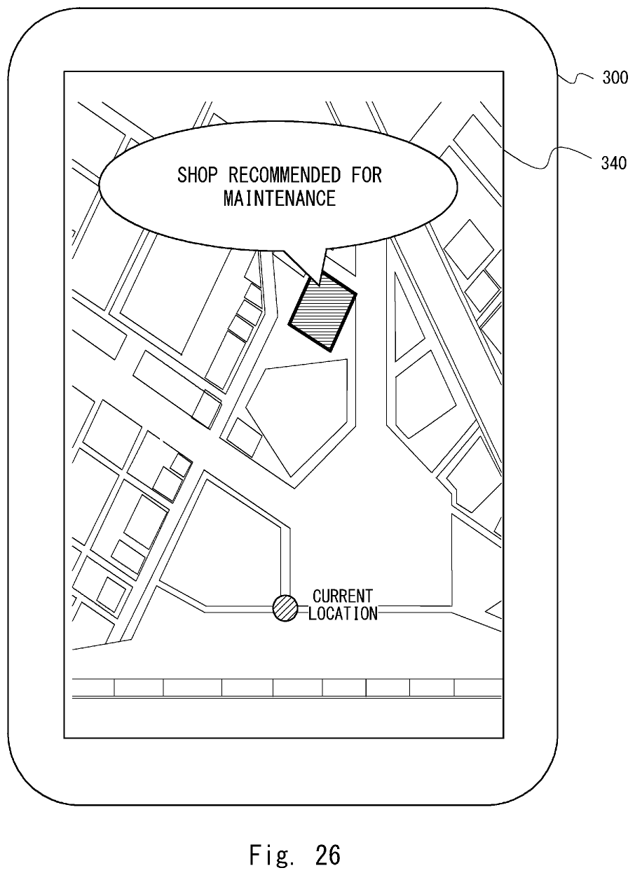

FIG. 26 is a diagram showing an example of a display on the user terminal 300 according to the fifth example embodiment. For example, on the display unit 340 of the user terminal 300, a user's current location and a location of the shop recommended for maintenance are displayed on a map. The user terminal 300 may further display route information from the user's current location to the shop recommended for maintenance.

Here, when the user visits the first shop, the server 200c may cause the shop terminal 400 to share the contract information of the user. In this case, the contract specifying unit 251 specifies a contract related to the vehicle of the user specified by the user specifying unit 243, and the output control unit 246 outputs contract information related to the contract to the shop terminal 400 of the first shop. Further, the output control unit 246 may output the user information of the user specified by the user specifying unit 243 to the shop terminal 400 of the first shop.

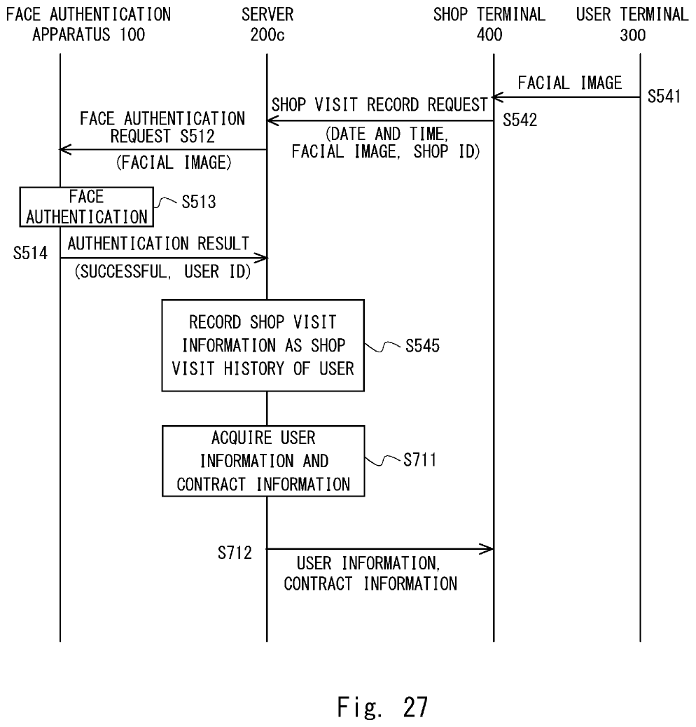

FIG. 27 is a sequence diagram showing a flow of information sharing processing according to the fifth example embodiment. In FIG. 27, as an example, when the user visits the first shop, the server 200c records the shop visit, and transmits the contract information and the user information to the shop terminal 400. Specifically, first, the same processes as S541 and S542, S512 to S514, and S545 described above are executed. Then, the contract specifying unit 251 of the server 200c refers to the user DB 212c, and acquires user information and contract information associated with the user ID, from the user DB 212c (S711). Then, the output control unit 246 of the server 200c transmits the user information and the contract information to the shop terminal 400 (S712).

Therefore, even when the user visits a shop other than the shop at which transactions are made in the past, the user information or the contract information can be easily taken over to the first shop visited by the user. When the business relationship between the contractor shop of the user and the first shop visited is distant, the output control unit 246 of the server 200c may not have to transmit the user information or the contract information to the shop terminal 400 of the first shop. In other words, the output control unit 246 of the server 200c may determine, based on relation information indicating the business relationship between the contractor shop of the user and the first shop visited, whether to transmit the user information or the contract information to the shop terminal 400 of the first shop. At this time, the output control unit 246 may restrict or prohibit for the user information or the contract information from being transmitted to the shop terminal 400 of the first shop when the degree of relationship is less than a predetermined threshold. Thus, it is possible to facilitate information sharing between the shops while taking into account business risks due to information sharing.

### Sixth Example Embodiment

Next, a sixth example embodiment of the present disclosure will be described. The sixth example embodiment differs from the second example embodiment in that the information processing system is a computer system that provides a user with sales promotion information about a shop visited by the user. In other words, the sixth example embodiment is a specific example of the first example embodiment. In the sixth example embodiment, the shop visited by the user may be, for example, a sales shop for service station or a shop for vehicle parts.

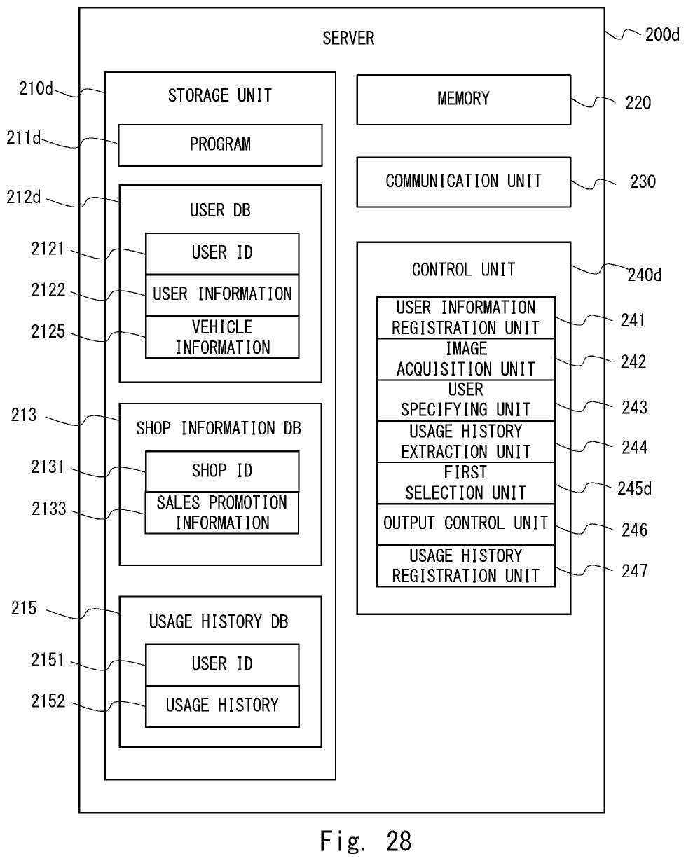

FIG. 28 is a block diagram showing a configuration of a server 200d according to the sixth example embodiment. The server 200d is an example of the information processing apparatus 10 according to the first example embodiment. The server 200d differs from the server 200 in that a storage unit 210d and a control unit 240d are provided instead of the storage unit 210 and the control unit 240.

The storage unit 210d stores a program 211d instead of the program 211 and a user DB 212d instead of the user DB 212. The program 211d is a computer program in which processing of information processing method according to the sixth example embodiment is implemented.

The user DB 212d stores vehicle information 2125 in addition to the user information 2122 in association with the user ID 2121. The vehicle information 2125 is information about a vehicle of the user, and may include, for example, information about a vehicle number, a vehicle type, or an oil type suitable for the vehicle.

In FIG. 28, the relation information 214 is omitted from the storage unit 210d, and the affiliated group 2132 is omitted from the shop information DB 213, but these components may not be omitted. Further, the sales promotion information 2133 of the shop information DB 213 is information about products or services dealing in the shop, and specifically includes sales promotion information about vehicle inspection, insurance, maintenance, sales, car sharing, or rental car. In addition, the sales promotion information 2133 may include sales promotion information regarding services related to inspection, maintenance, sales, insurance, or rental bicycles of other moving objects, such as bicycles, and sales promotion information about laundry services.

The control unit 240d includes a user information registration unit 241, an image acquisition unit 242, a user specifying unit 243, a usage history extraction unit 244, a first selection unit 245d, an output control unit 246, and a usage history registration unit 247.

The user information registration unit 241 of the server 200d registers vehicle information of the vehicle of the user in the user DB 212 in association with the user ID, in addition to the function of the user information registration unit 241 of the server 200.

The image acquisition unit 242 of the server 200d is an example of the image acquisition unit 12 described above. The image acquisition unit 242 of the server 200d has the same function as the image acquisition unit 242 of the server 200.

The user specifying unit 243 of the server 200d is an example of the user specifying unit 13 described above. The user specifying unit 243 of the server 200d has the same function as the user specifying unit 243 of the server 200.

Similarly to the usage history extraction unit 244 of the server 200, upon receiving an information provision request from the shop terminal 400, the usage history extraction unit 244 of the server 200d extracts a usage history associated with the user ID specified by the user specifying unit 243 from the usage history DB 215. Here, the usage history of the user is a usage history at a plurality of shops. The usage history extraction unit 244 supplies the extracted usage history to the first selection unit 245d.

The first selection unit 245d of the server 200d is an example of the selection unit 15 described above. The first selection unit 245d selects, based on the extracted usage history and the vehicle information of the user, recommended sales promotion information from the sales promotion information regarding products or services dealing in the first shop. For example, the first selection unit 245d estimates, based on the extracted usage history, a timing and type of maintenance. The timing and type of maintenance may be estimated using the vehicle information of the user in addition to the usage history. As an example, the first selection unit 245d may estimate the timing and type of maintenance based on a manufacturer or model of the vehicle of the user. Then, when maintenance is required within a predetermined period of time, the first selection unit 245d selects, as recommended sales promotion information, sales promotion information regarding a maintenance service from the sales promotion information regarding the products or services dealing in the first shop.

The first selection unit 245d may select recommended sales promotion information, based on the preference (or preferring a high-end product) of the user estimated from the usage history of the user or the attribute information of the user, in addition to the timing of the maintenance estimated from the usage history of the user. As an example, when it is estimated from the usage history of the user that the user is a person who prefers a high-end product, the first selection unit 245d may select, as recommended sales promotion information, sales promotion information regarding a maintenance service with the highest grade, from the maintenance services required by the user. Further, as an example, when it is estimated from an age or occupation of the user that the user has a thrifty mind, the first selection unit 245d may select, as recommended sales promotion information, sales promotion information regarding a maintenance service with the lowest grade, from the maintenance services required by the user.

The output control unit 246 of the server 200d is an example of the output control unit 16 described above. Similarly to the output control unit 246 of the server 200, the output control unit 246 of the server 200d transmits the sales promotion information selected by the first selection unit 245d to the shop terminal 400 of the first shop visited by the user, and causes the shop terminal 400 to display the information.

Similarly to the usage history registration unit 247 of the server 200, when the specified user uses the shop, the usage history registration unit 247 of the server 200d registers use information related to the use in the usage history DB in association with the user ID.

Here, information provision processing according to the sixth example embodiment will be described. Member registration processing and usage history registration processing according to the sixth example embodiment are the same as those of the second example embodiment, and thus will not be described.

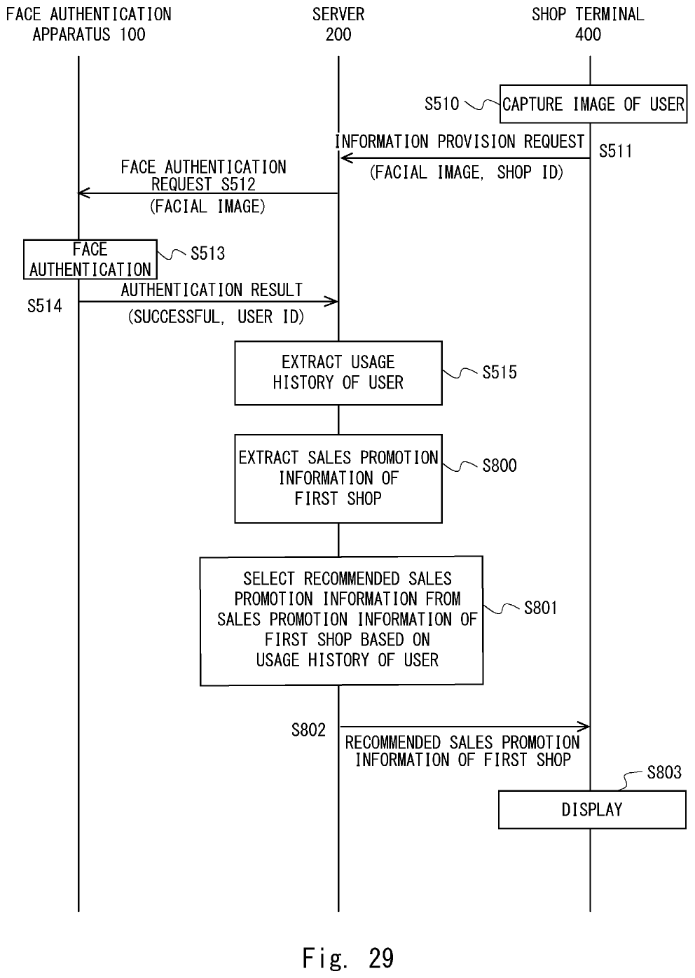

FIG. 29 is a sequence diagram showing a flow of the information provision processing according to the sixth example embodiment. The processing shown in FIG. 29 has S800 to S803 in addition to S510 to S515 shown in FIG. 14. First, processes of S510 to S515 are executed. Next, the first selection unit 245d extracts the sales promotion information of the first shop from the shop information DB 213 (S800). Next, the first selection unit 245d selects, based on the usage history of the user extracted in S515, recommended sales promotion information from the sales promotion information of the first shop (S801). Then, the output control unit 246 transmits the recommended sales promotion information to the shop terminal 400 of the first shop (S802). The shop terminal 400 displays the recommended sales promotion information on the display unit 440 (S803).

A specific example of the information provision processing is indicated below. For example, when a user visits a first shop, which is a service station, for the purpose of refueling a vehicle, the user is first specified by face authentication. Then, the first selection unit 245d grasps the most recent engine oil change date and mileage from the usage history of the user, and grasps from the vehicle information of the uses that the vehicle of the user is a light vehicle.

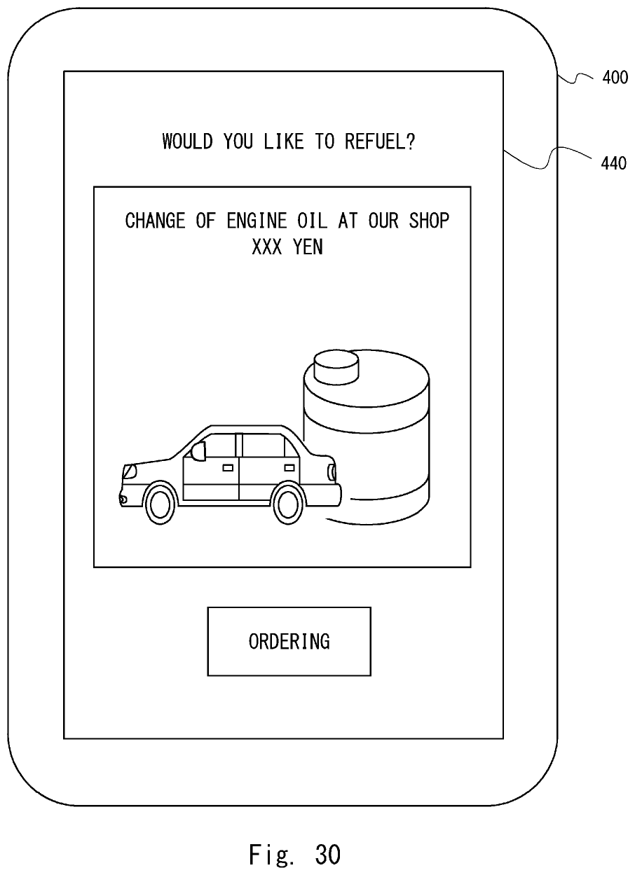

Then, the first selection unit 245d estimates a change date of engine oil based on the most recent engine oil change date, the mileage, and the vehicle model. Then, the first selection unit 245d selects, as a recommended service, a change service of engine oil from products or services of the first shop. In this case, a display screen shown in FIG. 30 may be displayed on the display unit 440 of the shop terminal 400.

FIG. 30 is a diagrams showing an example of a display on the shop terminal 400 according to the sixth example embodiment. For example, on the display screen, information about a change service of engine oil dealing in the first shop is displayed along with a message “Would you like to refuel?”. Further, an input region for ordering is displayed on the display screen, and the user can order a service by pressing the input region.

Here, the first selection unit 245d of the server 200d may estimate a vehicle state based on the captured image of the vehicle of the user, and may select, based on the vehicle state, recommended sales promotion information from the sales promotion information related to the first shop. As an example, the first selection unit 245d may estimate a dirty state of the vehicle from the captured image of the vehicle, and may select, as estimated sales promotion information, sales promotion information of a car wash service dealing in the first shop. Further, as an example, the first selection unit 245d reads a vehicle inspection seal from the captured image of the vehicle, and grasps that the vehicle is necessary to undergo an inspection as soon as possible. Then, the first selection unit 245d may select, as recommended sales promotion information, sales promotion information of the vehicle inspection service dealing in the first shop. Further, as an example, the first selection unit 245d may estimate a wear condition of tires from the captured image of the vehicle, and may select, as recommended sales promotion information, sales promotion information regarding tire products dealing in the first shop.

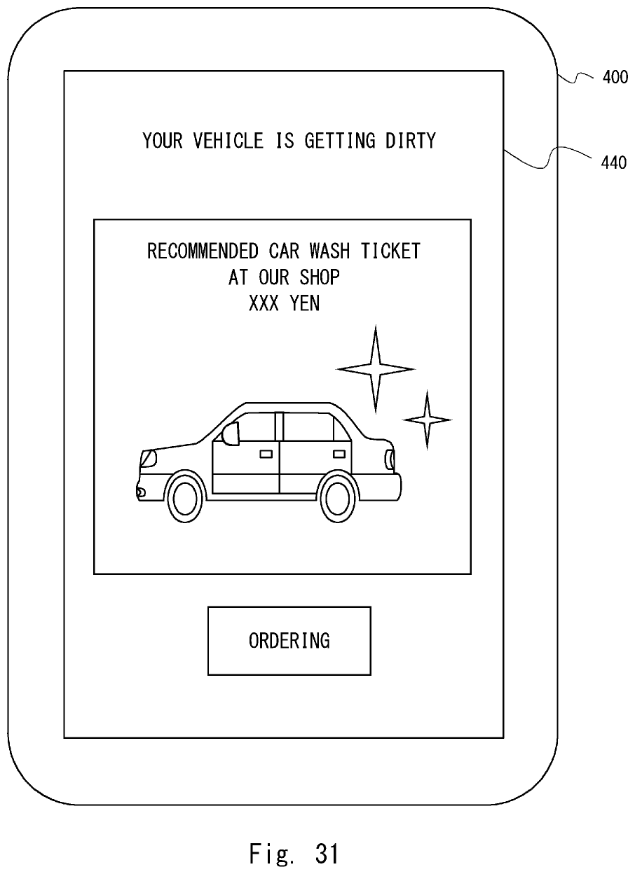

For example, when the first selection unit 245d estimates the dirty state of the vehicle from the captured image of the vehicle, a display screen shown in FIG. 31 may be displayed on the display unit 440 of the shop terminal 400. FIG. 31 is a diagram showing an example of a display on the shop terminal according to the sixth example embodiment. For example, on the display screen, information about a car wash tickets dealing in the first shop is displayed along with a message “Your vehicle is getting dirty”. Further, an input region for ordering is displayed on the display screen, and the user can order a ticket by pressing the input region.

According to the sixth example embodiment as described above, the server 200d narrows down products or services dealing in the shop based on the preference and needs of the user, and then preferably recommends the products or services to the user who has visited to a certain shop. Therefore, it becomes easier to attract customers to the shop while increasing satisfaction of the user, leading to an increase in profits of the shop.

In the sixth example embodiment described above, it is assumed that the image acquisition unit 242 captures the face of the user and the user specifying unit 243 specifies the user ID. However, alternatively, the image acquisition unit 242 may capture the vehicle of the user, and the user specifying unit 243 may specify the vehicle ID. The vehicle ID is, for example, a vehicle number. In this case, the usage history registration unit 247 may register the usage history in the usage history DB 215 in association with the vehicle ID. Then, the usage history extraction unit 244 may extract the usage history associated with the vehicle ID specified by the user specifying unit 243.

Further, the first selection unit 245d may feedback the effect of sales promotions thus far to the next selection process. For example, the first selection unit 245d may calculate a utilization rate due to the sales promotion, and select the recommended sales promotion information based on the calculated rate. Here, the utilization rate due to the sales promotion is the number of times the recommended sales promotion information is output and the product or service of the shop is used (also called purchased) among the number of times the recommended sales promotion information is output. The “recommended sales promotion information is output and the shop is used” may include a case where the user uses the product or service indicated by the recommended sales promotion information within a predetermined time after the recommended sales promotion information is output. Further, the “recommended sales promotion information is output and the shop is used” may include a case where the user orders the product or service by pressing the input region displayed on the screen on which the recommended sales promotion information is displayed. As an example, the first selection unit 245d may select the recommended sales promotion information by excluding the recommended sales promotion information recommended in the past or by lowering the priority when the utilization rate due to the sales promotion is less than a predetermined threshold.

This is because there is a high possibility that the recommended sales promotion information recommended in the past is unnecessary or uninteresting information for the user.

In addition, for example, in the selection processing, the first selection unit 245d may preferentially select the sales promotion information related to the products or services for which the shop is used as a result of the output of the recommended sales promotion information. Conversely, the first selection unit 245d may lower the priority of the sales promotion information related to the products or services for which the shop is not used as a result of the output of the recommended sales promotion information.

In order to realize the above processing, when the user specified by the user specifying unit 243 or the user who uses the specified vehicle uses the output recommended sales promotion information, the usage history registration unit 247 may register the use information related to the use in the usage history DB 215 in association with the user ID or the vehicle ID as the usage history that leads to the use of the first shop as a result of the output of the recommended sales promotion information.

Thus, the effect of sales promotion can be appropriately fed back to the selection processing, and the satisfaction of the user can be improved.

In addition, as in the second example embodiment, the first selection unit 245d may adjust the quantity or quality of recommended sales promotion information to be selected based on the usage history at stores in the affiliated group or alliance group related to the specified user or vehicle. Whether each of the shops is the shop as the first shop in the affiliated group or alliance group may be determined using the information related to the affiliated groups and the relation information described in the second example embodiment. As an example, as the amount of money spent or the visiting frequency in the affiliated group or alliance group increases, the first selection unit 245d may increase the quantity of recommended sales promotion information, select sales promotion information with a high discount rate, or preferentially select sales promotion information including discount information. Thus, regular customers of shops belonging to the same affiliated group or alliance group, although the shops are different, can be served not as customers of the shop but as customers of the same affiliated brand or alliance brand.

### Seventh Example Embodiment

A seventh example embodiment of the present disclosure will be described below. The seventh example embodiment is characterized in that the information processing of the server 200d according to the sixth example embodiment is executed by a shop management apparatus 500 that manages the shop terminal 400. This configuration is effective when it is desired to manage sales promotion information and customer information of each shop only within the own shop or group without sharing with the server.

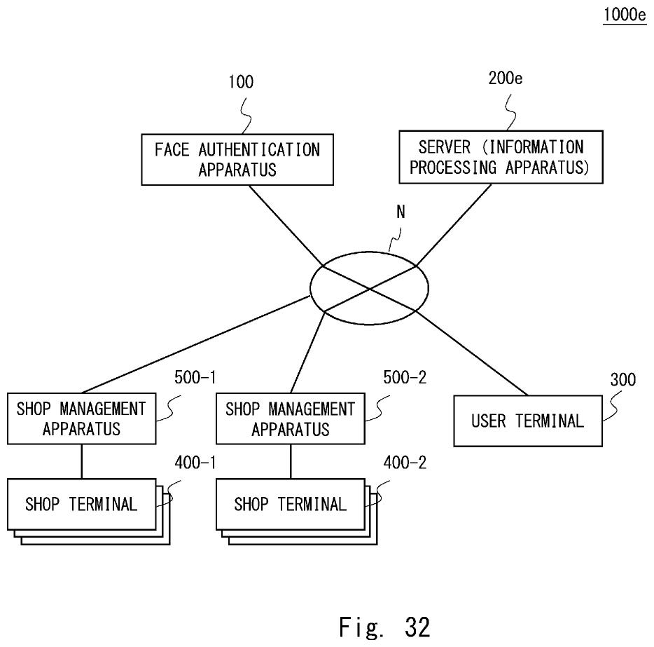

FIG. 32 is a block diagram showing an overall configuration of an information processing system 1000e according to the seventh example embodiment. The information processing system 1000e includes a server 200e instead of the server 200, and a shop management apparatus 500.

The shop management apparatus 500 is a computer apparatus that manages the shop terminals 400 installed in one or a plurality of shops. The shop management apparatus 500 is connected to a network N. The shop management apparatus 500 may manage only the shop terminal 400 installed in one shop, or may manage the shop terminals 400 installed in a plurality of shops belonging to the same affiliated group or alliance group.

The shop management apparatus 500 receives a facial image of a user who visits the shop, from the shop terminal 400 connected to the shop management apparatus 500, and executes user specifying processing, usage history extraction processing, selection processing, output control processing, and usage history registration processing.

The server 200e is configured to store the usage history DB 215 and to reply the usage history associated with the user ID to the shop management apparatus 500 when receiving a reference request specifying the user ID from the shop management apparatus 500.

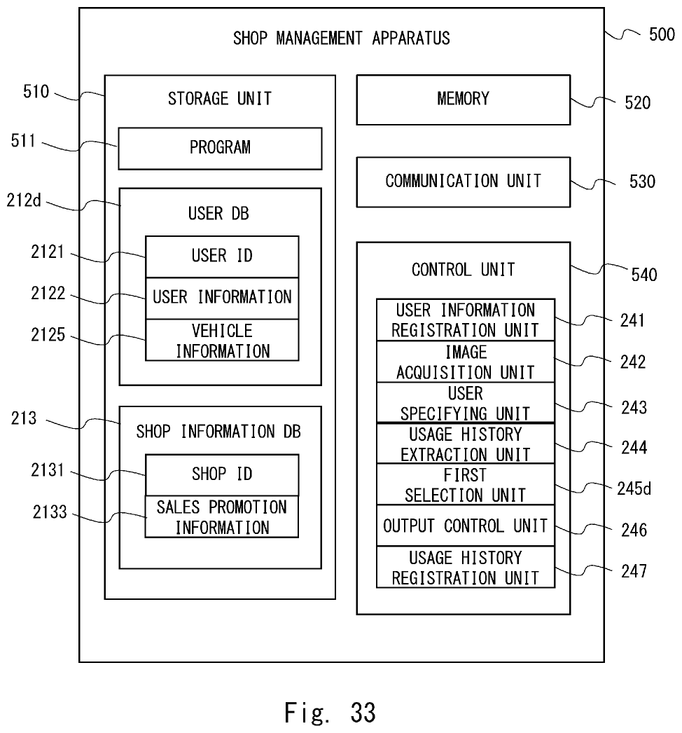

FIG. 33 is a block diagram showing a configuration of the shop management apparatus 500 according to the seventh example embodiment. The shop management apparatus 500 includes a storage unit 510, a memory 520, a communication unit 530, and a control unit 540. The storage unit 510 is a storage apparatus such as a hard disk or a flash memory. The storage unit 510 stores a program 511, and a user DB 212d and a shop information DB 213 having the same configuration as the server 200d according to the sixth example embodiment. The program 511 is a computer program in which the processing of the information processing method according to the present seventh example embodiment is implemented. The memory 520 is a volatile storage apparatus such as RAM, and is a storage region for temporarily retaining information when the control unit 540 is operating. The communication unit 530 is a communication interface with the network N.

The control unit 540 is a process, that is, a control apparatus that controls each of the components of the shop management apparatus 500. The control unit 540 causes the memory 520 to read the program 511 from the storage unit 510 and executes the program 511. Thus, the control unit 540 realizes functions of a user information registration unit 241, an image acquisition unit 242, a user specifying unit 243, a usage history extraction unit 244, a first selection unit 245d, an output control unit 246, and a usage history registration unit 247 that have the same functions as those of the server 200d.

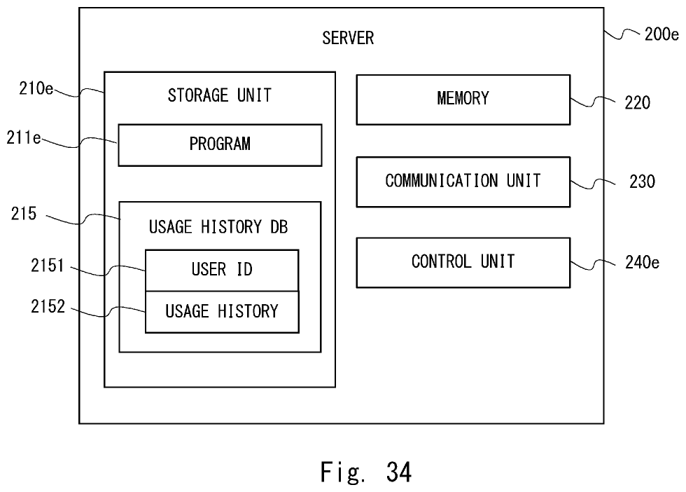

FIG. 34 is a block diagram showing a configuration of the server 200e according to the seventh example embodiment. The server 200e differs from the server 200d in that a storage unit 210e and a control unit 240e are provided instead of the storage unit 210d and the control unit 240d.

The storage unit 210e stores a program 211e and a usage history DB 215. The program 211e is a computer program in which reference response processing by the control unit 240e, which will be described below, is implemented.

The control unit 240e replies the usage history associated with the user ID in the usage history DB 215 to the shop management apparatus 500 when receiving a reference request specifying the user ID from the shop management apparatus 500.

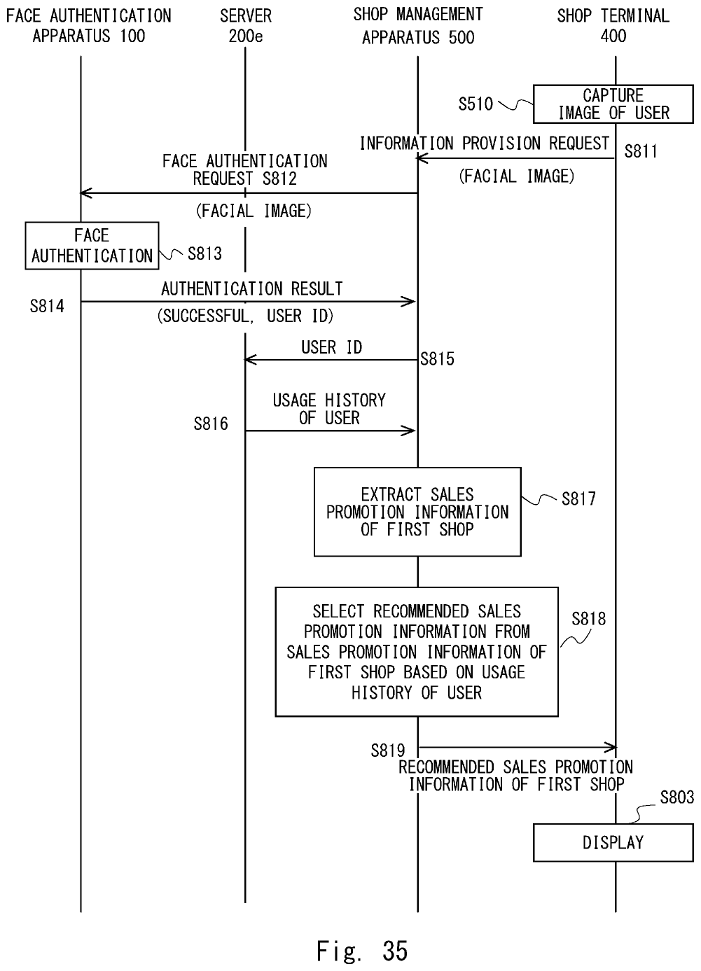

FIG. 35 is a sequence diagram showing a flow of the information provision processing according to the seventh example embodiment. The processing showing in FIG. 35 has S811 to S819 instead of S511 to S515 and S800 to S802 shown in FIG. 29. First, the shop terminal 400 of the first shop captures an image of the user who visits the first shop (S510). Then, the shop terminal 400 transmits the information provision request to the shop management apparatus 500 (S811). The information provision request includes the facial image generated by the capturing. When the shop management apparatus 500 manages the shop terminals 400 of a plurality of shops, the information provision request may include a shop ID.

Next, the user specifying unit 243 of the shop management apparatus 500 transmits a face authentication request for a facial region of a user U in the facial image to the face authentication apparatus 100 (S812). Then, the face authentication apparatus 100 performs face authentication on the facial region of the user U in the facial image included in the received face authentication request (S813). Here, it is assumed that there is a user ID for which the face authentication has succeeded. The face authentication apparatus 100 transmits a face authentication result including the fact that the face authentication is successful and the user ID 111, to the shop management apparatus 500 (S814).

Next, the usage history extraction unit 244 of the shop management apparatus 500 transmits the reference request including the specified user ID to the server 200e (S815). Next, the control unit 460e of the server 200e extracts, from the usage history DB 215, the usage history associated with the user ID included in the face authentication result, and replies the extracted usage history of the user to the shop management apparatus 500 (S816). Then, the shop management apparatus 500 executes S817 to S819, which are the same processes as S800 to S802 in FIG. 29. The shop terminal 400 displays the recommended sales promotion information on the display unit 440 (S803).

### Other FIRST Example Embodiment

In the second example embodiment described above, the server 200 executes the face payment process after designating the billing destination for the use of the shop as the user (for example, 5535 in FIG. 15). However, alternatively, the server 200 may determine whether a fee for use of the shop is charged, or a billing destination or the amount of billing, based on the relationship between the company to which the user belongs and the first shop.

For example, it is assumed that the company to which the user belongs has concluded a corporate contract with the first shop regarding a subscription service for employees of the company as part of its welfare program. In this case, the server 200 does not charge the user a fee for use of the shop. Instead, the server 200 charges the company to which the user belongs for the usage fee of the subscription service. Further, for example, it is assumed that the company to which the user belongs has concluded a corporate contract, in which the company bears part of the amount spend by employees of the company, with the first shop. In this case, the server 200 charges the company for some of the fees for using the shop, and charges the user for the rest.

In order to realize the processing based on the relationship between the company to which the user belongs and the first shop as described above, the user DB 212 of the storage unit 210 of the server 200 may store an ID of the company to which the user belongs, in association with the user ID. In addition, the storage unit 210 of the server 200 may further include information about a corporate contract between each company and each shop.

Even when the user's family visits the first shop, the server 200 may determine whether a fee for use of the shop is charged, or a billing destination or the amount of billing, based on the relationship between the company to which the user belongs and the first shop. In this case, the user ID of the user and a user ID of the user's family may be linked in the user DB 212 of the storage unit 210 of the server 200.

In this way, it is possible to apply the information processing system 1000 to a new business model called BtoBtoE by making it possible to execute face payment processing in consideration of the content of a corporate contract.

The above-described example embodiments have been described as hardware configuration, but are not limited thereto. The present disclosure can also implement any processing by causing a processor to execute a computer program.

In the above-described examples, the program includes instructions (or software codes) that, when loaded into a computer, causes a computer to perform one or more functions described in the example embodiments. The program may be stored in a non-transitory computer-readable medium or a tangible storage medium. Examples of computer-readable media or tangible storage media may include a random-access memory (RAM), a read-only memory (ROM), a flash memory, a solid-state drive (SSD) or other memory technology, a CD-ROM, a digital versatile disc (DVD), a Blu-ray (registered trademark) disc or other optical storages, a magnetic cassette, a magnetic tape, and a magnetic storage or other magnetic storage devices. The program may be transmitted on a transitory computer-readable medium or a communication medium. Examples of transitory computer-readable media or communication media may include electric signals, optical signals, acoustic signals, or other forms of propagated signals.

The present disclosure is not limited to the above-described example embodiments, and can be modified as appropriate without departing from the scope and spirit of the invention. For example, the third and fourth example embodiments or the third and fifth example embodiments can be combined. Further, for example, the second and sixth example embodiments or the third and sixth example embodiments may be combined. In addition, the processing according to the second to fourth example embodiments may be executed by the shop management apparatus 500 of the seventh example embodiment.

For example, the face authentication is used as the user specifying means in the example embodiments described above, but fingerprint, iris, palm, or vein authentication, gait, or other biometric authentication may be used instead of the face authentication. In this case, the shop terminal 400 may transmit the captured image of the user captured by the shop terminal 400 and the biometric information read by the shop terminal 400, via the server 200, to the face authentication apparatus 100 (biometric authentication apparatus), and specify the user ID with the biometric authentication designated by the face authentication apparatus 100. The specified user ID is replied to the server 200.

Further, the face authentication apparatus 100 has the face authentication function in the example embodiments described above, but instead of or in addition to the face authentication apparatus 100, the server 200 may have the face authentication function.

Some or all of the above-described example embodiments may also be described as in the following Supplementary Notes, but are not limited to the following.

### Supplementary Note A1

An information processing apparatus comprising:

image acquisition means for acquiring a captured image obtained by capturing an image of a user who visits a first shop;

user specifying means for specifying the user based on the captured image;

selection means for selecting, based on user information related to the user and relation information indicating a business relationship between each of a plurality of shops and the first shop, at least one sales promotion information related to at least one of the plurality of shops, as recommended sales promotion information related to a recommended shop; and output control means for outputting the recommended sales promotion information.

### Supplementary Note A2

In the information processing apparatus according to Supplementary Note A1, the user information includes at least of attribute information of the user, information indicating preference of the user, and a usage history indicating that the user uses any of the plurality of shops.

### Supplementary Note A3

In the information processing apparatus according to Supplementary Note A2, the selection means

selects, as the recommended shop, the at least one shop from the plurality of shops, based on the relation information, and selects, as the recommended sales promotion information, the at least one sales promotion information from a plurality of pieces of sales promotion information related to the recommended shop, based on the user information.

### Supplementary Note A4

In the information processing apparatus according to any one of Supplementary Notes A1 to A3, the information processing apparatus further includes facial condition generation means for generating facial condition information about a facial condition of the user from the captured image, and the selection means selects the recommended sales promotion information related to the recommended shop, based on the user information, the relation information, and the facial condition information.

### Supplementary Note A5

In the information processing apparatus according to any one of Supplementary Notes A1 to A3, the recommended shop differs in a type of business to be operated, from the first shop.

### Supplementary Note A6

In the information processing apparatus according to any one of Supplementary Notes A1 to A5, the selection means selects the recommended sales promotion information related to the recommended shop, based on a cycle corresponding to a type of product purchased by the user or a cycle corresponding to a type of service used by the user.

### Supplementary Note A7

In the information processing apparatus according to any one of Supplementary Notes A1 to A6, the information processing apparatus further includes opportunity loss calculation means for acquiring shop visit information indicating that the user visits the first shop, and generating opportunity loss information based on a number of times the user visits the first shop and a number of times the user uses the first shop, and the selection means selects the recommended sales promotion information related to the recommended shop, based on the user information, the relation information, and the opportunity loss information of the user.

### Supplementary Note A8

In the information processing apparatus according to any one of Supplementary Notes A1 to A7, the selection means adjusts the quantity or quality of sales promotion information to be selected, based on the amount of money spent by the user in a group to which the first shop belongs, or a visiting frequency of the user to one or a plurality of shops belonging to the group.

### Supplementary Note A9

An information processing system comprising:

an information processing apparatus; and

a terminal that provides information to a user who visits a first shop,

the information processing apparatus including:

image acquisition means for acquiring a captured image obtained by capturing an image of a user who visits a first shop;

user specifying means for specifying the user based on the captured image;

selection means for selecting, based on user information related to the user and relation information indicating a business relationship between each of a plurality of shops and the first shop, at least one sales promotion information related to at least one of the plurality of shops, as recommended sales promotion information related to a recommended shop; and

output control means for outputting the recommended sales promotion information.

### Supplementary Note A10

In the information processing system according to Supplementary Note A9, the information processing system further includes a biometric authentication apparatus that acquires the captured image from the terminal and executes biometric authentication using the captured image.

### Supplementary Note A11

An information processing method comprising: acquiring a captured image obtained by capturing an image of a user who visits a first shop;

specifying the user based on the captured image;

selecting, based on user information related to the user and relation information indicating a business relationship between each of a plurality of shops and the first shop, at least one sales promotion information related to at least one of the plurality of shops, as recommended sales promotion information related to a recommended shop; and

outputting the recommended sales promotion information.

### Supplementary Note A12

A non-transitory computer-readable medium storing a program that causes a computer to execute:

an image acquisition process for acquiring a captured image obtained by capturing an image of a user who visits a first shop;

a user specifying process for specifying the user based on the captured image;

a selection process for selecting, based on user information related to the user and relation information indicating a business relationship between each of a plurality of shops and the first shop, at least one sales promotion information related to at least one of the plurality of shops, as recommended sales promotion information related to a recommended shop; and

an output control process for outputting the recommended sales promotion information.

### Supplementary Note B1

An information processing apparatus comprising:

contract specifying means for specifying, from a user terminal used by a user, when acquiring information about a state of a vehicle of the user and position information of the user, a contract related to the vehicle of the user;

selection means for selecting, as recommended shop, at least one shop from shops capable of performing maintenance corresponding to the state, based on information about a contractor shop, which is a shop with which the contract is made, and the position information of the user; and

output control means for outputting information related to the recommended shop to the user terminal.

### Supplementary Note B2

In the information processing apparatus according to Supplementary Note B1, the contractor shop includes a shop where the user purchases, rents, or leases the vehicle.

### Supplementary Note B3

In the information processing apparatus according to Supplementary Note B1 or B2, the selection means selects the recommended shop from the shop capable of performing the maintenance corresponding to the state, based on relation information indicating a business relationship between each of a plurality of shops and the contractor shop and the position information of the user.

### Supplementary Note B4

In the information processing apparatus according to any one of Supplementary Notes B1 to B3, the selection means selects the recommended shop from the shop capable of performing the maintenance corresponding to the state, based on the information about the contractor shop, the position information of the user, and a contract content about the vehicle.

### Supplementary Note B5

In the information processing apparatus according to any one of Supplementary Notes B1 to B4, the selection means

specifies a type of the maintenance based on the information about the state, and

determines, based on inventory information about parts adapted to the type of the maintenance, whether each of the plurality of shops is capable of performing the maintenance corresponding to the state.

### Supplementary Note B6

In the information processing apparatus according to any one of Supplementary Notes B1 to B5, the information processing apparatus further includes:

image acquisition means for acquiring a captured image obtained by capturing an image of a user who visits a first shop; and

user specifying means for specifying the user based on the captured image,

the contract specifying means specifies a contract related to the vehicle of the specified user, and

the output control means outputs contract information related to the contract to a terminal of the first shop.

### Supplementary Note B7

An information processing system comprising:

an information processing apparatus; and

a user terminal used by a user,

the information processing apparatus including:

specifying, from a user terminal, when acquiring information about a state of a vehicle of the user and position information of the user, a contract related to the vehicle of the user;

selection means for selecting, as recommended shop, at least one shop from shops capable of performing maintenance corresponding to the state, based on information about a contractor shop, which is a shop with which the contract is made, and the position information of the user; and

output control means for outputting information related to the recommended shop to the user terminal.

### Supplementary Note B8

An information processing method comprising:

specifying, from a user terminal used by a user, when acquiring information about a state of a vehicle of the user and position information of the user, a contract related to the vehicle of the user;

selecting, as recommended shop, at least one shop from shops capable of performing maintenance corresponding to the state, based on information about a contractor shop, which is a shop with which the contract is made, and the position information of the user; and

outputting information related to the recommended shop to the user terminal.

### Supplementary Note B9

A non-transitory computer-readable medium storing a program that causes a computer to execute:

a contract specifying process for specifying, from a user terminal used by a user, when acquiring information about a state of a vehicle of the user and position information of the user, a contract related to the vehicle of the user;

a selection process for selecting, as recommended shop, at least one shop from shops capable of performing maintenance corresponding to the state, based on information about a contractor shop, which is a shop with which the contract is made, and the position information of the user; and

an output control process for outputting information related to the recommended shop to the user terminal.

### Supplementary Note C1

An information processing apparatus comprising:

image acquisition means for acquiring a captured image of at least one of a user who visits a first shop and a vehicle used by the user;

user specifying means for specifying the user or the vehicle based on the captured image;

selection means for selecting, as recommended sales promotion information, at least one piece of sales promotion information from pieces of sales promotion information related to a product or service dealing in the first shop, based on a usage history regarding the user or the vehicle at a plurality of shops; and

output control means for outputting the recommended sales promotion information.

### Supplementary Note C2

In the information processing apparatus according to Supplementary Note C1, the sales promotion information includes sales promotion information about a service related to vehicle inspection, insurance, maintenance, sales, car sharing, or rental car.

### Supplementary Note C3

In the information processing apparatus according to Supplementary Note C1 or C2, the selection means selects, as the recommended sales promotion information, at least one of sales promotion information from pieces of sales promotion information related to the first shop, based on a state of the vehicle estimated based on the captured image of the vehicle.

### Supplementary Note C4

In the information processing apparatus according to any one of Supplementary Notes C1 to C3, the selection means selects, as the recommended sales promotion information, at least one of sales promotion information from pieces of sales promotion information related to the first shop, based on attribute information of the user or a model of the vehicle used by the user.

### Supplementary Note C5

In the information processing apparatus according to any one of Supplementary Notes C1 to C4, the information processing apparatus further includes usage history registration means for registering, when the specified user or a user using the specified vehicle uses the first shop, use information related to the use in a usage history DB in association with an ID of the user or the vehicle.

### Supplementary Note C6

In the information processing apparatus according to Supplementary Note C5, the usage history registration means registers, when the specified user or a user using the specified vehicle makes a use related to the recommended sales promotion information to be output, use information related to the use in the usage history DB in association with the ID of the user or the vehicle, as a usage history of use of the first shop as a result of outputting the recommended sales promotion information.

### Supplementary Note C7

In the information processing apparatus according to Supplementary Note C6, the selection means

calculates a ratio of the number of times the recommended sales promotion information is output and used by the shop, out of the number of times the recommended sales promotion information is output, and selects, as the recommended sales promotion information, at least one sales promotion information from pieces of sales promotion information, based on the ratio.

### Supplementary Note C8

In the information processing apparatus according to any one of Supplementary Notes C1to C7, the selection means adjust the quantity or quality of the recommended sales promotion information to be selected, based on a usage history at each shop whose degree of business relationship with the first shop is equal to or greater than a predetermined threshold, among the usage history.

### Supplementary Note C9

An information processing system comprising:

an information processing apparatus; and

a terminal that provides information to a user who visits a first shop,

the information processing apparatus including:

image acquisition means for acquiring a captured image of at least one of a user who visits a first shop and a vehicle used by the user;

user specifying means for specifying the user or the vehicle based on the captured image;

selection means for selecting, as recommended sales promotion information, at least one piece of sales promotion information from pieces of sales promotion information related to a product or service dealing in the first shop, based on a usage history regarding the user or the vehicle at a plurality of shops; and

output control means for outputting the recommended sales promotion information.

### Supplementary Note C10

An information processing method comprising: acquiring a captured image of at least one of a user who visits a first shop and a vehicle used by the user;

specifying the user or the vehicle based on the captured image;

selecting, as recommended sales promotion information, at least one piece of sales promotion information from pieces of sales promotion information related to a product or service dealing in the first shop, based on a usage history regarding the user or the vehicle at a plurality of shops; and

outputting the recommended sales promotion information.

### Supplementary Note C11

A non-transitory computer-readable medium storing a program that causes a computer to execute:

an image acquisition process for acquiring a captured image of at least one of a user who visits a first shop and a vehicle used by the user;

a user specifying process for specifying the user or the vehicle based on the captured image;

a selection process for selecting, as recommended sales promotion information, at least one piece of sales promotion information from pieces of sales promotion information related to a product or service dealing in the first shop, based on a usage history regarding the user or the vehicle at a plurality of shops; and

an output control process for outputting the recommended sales promotion information.

### Reference Signs List

10, 200, 200a, 200b, 200c, 200e INFORMATION PROCESSING APPARATUS (SERVER)
15 SELECTION UNIT
100 FACE AUTHENTICATION APPARATUS
110 FACIAL INFORMATION DB
111 USER ID
112 FACIAL FEATURE INFORMATION
120 FACE DETECTION UNIT
130 FEATURE POINT EXTRACTION UNIT
140 REGISTRATION UNIT
150 AUTHENTICATION UNIT
210, 210a, 210b, 210c, 210d, 210e STORAGE UNIT
211, 211a, 211b, 211c, 211d, 211e PROGRAM
212, 212a, 212c, 212d USER DB
2121 USER ID
2122 USER INFORMATION
2123 OPPORTUNITY LOSS INFORMATION
2124 CONTRACT INFORMATION
2125 VEHICLE INFORMATION
213, 213c, 213d SHOP INFORMATION DB
2131 SHOP ID
2132 AFFILIATED GROUP
2133 SALES PROMOTION INFORMATION
2134 AVAILABLE MAINTENANCE
214 RELATION INFORMATION
215 USAGE HISTORY DB
2151 USER ID
2152 USAGE HISTORY
220 MEMORY
230 COMMUNICATION UNIT
240, 240a, 240b, 240c, 240d, 240e CONTROL UNIT
241 USER INFORMATION REGISTRATION UNIT
12, 242 IMAGE ACQUISITION UNIT
13, 243 USER SPECIFYING UNIT
244 USAGE HISTORY EXTRACTION UNIT
245, 245a, 245b, 245d FIRST SELECTION UNIT
16, 246 OUTPUT CONTROL UNIT
247 USAGE HISTORY REGISTRATION UNIT
248 OPPORTUNITY LOSS CALCULATION UNIT
249 FACIAL CONDITION GENERATION UNIT
250 VEHICLE STATE ACQUISITION UNIT
251 CONTRACT SPECIFYING UNIT
252 SECOND SELECTION UNIT
300 USER TERMINAL
310 CAMERA
320 STORAGE UNIT
330 COMMUNICATION UNIT
340 DISPLAY UNIT
350 INPUT UNIT
360 CONTROL UNIT
400 SHOP TERMINAL
410 CAMERA
420 STORAGE UNIT
430 COMMUNICATION UNIT
440 DISPLAY UNIT
450 INPUT UNIT
460 CONTROL UNIT
500 SHOP MANAGEMENT APPARATUS
510 STORAGE UNIT
511 PROGRAM
520 MEMORY
530 COMMUNICATION UNIT
540 CONTROL UNIT
1000, 1000e INFORMATION PROCESSING SYSTEM

What is claimed is:

1. An information processing apparatus comprising:
at least one memory storing instructions; and
at least one processor configured to execute the instructions to:
acquire a captured image of at least one of a user who visits a first shop and a vehicle used by the user;
specify the user or the vehicle based on the captured image;
select, as recommended sales promotion information, at least one piece of sales promotion information from pieces of sales promotion information related to a product or service dealing in the first shop, based on a usage history regarding the user or the vehicle at a plurality of shops; and
output the recommended sales promotion information.

2. The information processing apparatus according to claim 1, wherein the sales promotion information includes sales promotion information about a service related to vehicle inspection, insurance, maintenance, sales, car sharing, or rental car.

3. The information processing apparatus according to claim 1, wherein the at least one processor is further configured to execute the instructions to:
select, as the recommended sales promotion information, at least one of sales promotion information from pieces of sales promotion information related to the first shop, based on a state of the vehicle estimated based on the captured image of the vehicle.

4. The information processing apparatus according to claim 1, wherein the at least one processor is further configured to execute the instructions to:
select, as the recommended sales promotion information, at least one of sales promotion information from pieces of sales promotion information related to the first shop, based on attribute information of the user or a model of the vehicle used by the user.

5. The information processing apparatus according to claim 1, wherein the at least one processor is further configured to execute the instructions to:
register, when the specified user or a user using the specified vehicle uses the first shop, use information related to the use in a usage history DB in association with an ID of the user or the vehicle.

6. The information processing apparatus according to claim 5, wherein the at least one processor is further configured to execute the instructions to:
register, when the specified user or a user using the specified vehicle makes a use related to the recommended sales promotion information to be output, use information related to the use in the usage history DB in association with the ID of the user or the vehicle, as a usage history of use of the first shop as a result of outputting the recommended sales promotion information.

7. The information processing apparatus according to claim 6, wherein the at least one processor is further configured to execute the instructions to:
calculate a ratio of the number of times the recommended sales promotion information is output and used by the shop, out of the number of times the recommended sales promotion information is output, and
select, as the recommended sales promotion information, at least one sales promotion information from pieces of sales promotion information related to the first shop, based on the ratio.

8. The information processing apparatus according to claim 1, wherein the at least one processor is further configured to execute the instructions to:
adjust the quantity or quality of the recommended sales promotion information to be selected, based on a usage history at each shop whose degree of business relationship with the first shop is equal to or greater than a predetermined threshold, among the usage history.

9. (canceled)

10. An information processing method comprising:
acquiring a captured image of at least one of a user who visits a first shop and a vehicle used by the user;
specifying the user or the vehicle based on the captured image;
selecting, as recommended sales promotion information, at least one piece of sales promotion information from pieces of sales promotion information related to a product or service dealing in the first shop, based on a usage history regarding the user or the vehicle at a plurality of shops; and
outputting the recommended sales promotion information.

11. A non-transitory computer-readable medium storing a program that causes a computer to execute:
an image acquisition process for acquiring a captured image of at least one of a user who visits a first shop and a vehicle used by the user;
a user specifying process for specifying the user or the vehicle based on the captured image;
a selection process for selecting, as recommended sales promotion information, at least one piece of sales promotion information from pieces of sales promotion information related to a product or service dealing in the first shop, based on a usage history regarding the user or the vehicle at a plurality of shops; and
an output control process for outputting the recommended sales promotion information.
